(19) United States
(12) Patent Application Publication
(10) Pub. No.: US 2011/0285665 A1
(43) Pub. Date: Nov. 24, 2011

(54) INPUT DEVICE, INPUT METHOD, PROGRAM, AND RECORDING MEDIUM

(76) Inventor: Takashi MATSUMOTO, Osaka (JP)

(21) Appl. No.: 13/049,359

(22) Filed: Mar. 16, 2011

(30) Foreign Application Priority Data
May 18, 2010 (JP) 2010-114684
Feb. 22, 2011 (JP) 2011-036188

(51) Int. Cl. G06F 3/045

(52) U.S. Cl. 345/174

(57) ABSTRACT

To provide an input device with improved operability. The input device includes: a display panel that displays a plurality of icons; a trajectory calculating unit that extracts a trajectory of movement of a finger for selecting an icon; a direction estimating unit that estimates a direction in which the finger is going to move, from the trajectory; an image processing unit that rearranges the plurality of icons based on the estimated direction; and a selection detecting unit that detects that an icon is selected by the finger.

### BACKGROUND OF THE INVENTION

1. Field of the Invention

The present invention relates to an input device and an input method.

2. Related Art of the Invention

Information terminals such as PDAs, smartphones, tablet PCs, and car navigation systems are recently becoming widely used. For downsizing purposes, such information terminals typically adopt a touch panel used to input information by touching a GUI (Graphical User Interface) such as an icon displayed on a display with a touch pen or a finger. With a touch panel, a plurality of icons are displayed on a display screen, and by touching an icon with a stylus or a finger, the icon can be selected and an application program assigned to the icon can be activated.

A configuration of such an information terminal is proposed which enables a launcher GUI including one or more icons to be activated using only one hand (for example, refer to Japanese Patent Laid-Open No. 2009-110286). With the information terminal described in Japanese Patent Laid-Open No. 2009-110286, a display instruction of a launcher button is inputted by moving a finger on a touch panel while gripping the information terminal and the launcher button is displayed at a contact-corresponding position corresponding to a contact position of the finger. By performing a predetermined operation with the finger while touching the launcher button, a display instruction of the launcher GUI is inputted and a launcher GUI including one or more icons is displayed.

Touch panels are also widely used in operation screens of a bank ATM, devices such as copy machines, and the like. A plurality of buttons are displayed on such an operation panel, and by operating the buttons with a finger, operation instructions can be inputted and functions assigned to the button can be performed.

A configuration of such a device is proposed in which when an operation involving sliding a finger across a touch panel is performed, a direction of movement is judged and an operating button existing ahead in the direction of movement from the current contact position is displayed enlarged (for example, refer to Japanese Patent Laid-Open No. 2008-21094).

### SUMMARY OF THE INVENTION

However, with both Japanese Patent Laid-Open No. 2009-110286 and Japanese Patent Laid-Open No. 2008-21094, performing an input operation requires a user to move a finger on a screen while maintaining contact with the screen, which may sometimes make it difficult to perform operations.

The present invention is made in consideration of problems found in conventional input devices, and an object thereof is to provide an input device and an input method with improved operability.

To achieve the above object, the 1^{st} aspect of the present invention is an input device comprising:

a display panel that displays a plurality of screen components;

a trajectory detecting unit that detects a trajectory of movement of a designating object for selecting the screen components;

a direction estimating unit that estimates a direction in which the designating object is going to move, from the trajectory;

a display control unit that rearranges the plurality of screen components based on the estimated direction; and

a selection detecting unit that detects that one of the screen components is selected by the designating object.

The 2^{nd} aspect of the present invention is the input device according to the 1^{st} aspect of the present invention, further comprising

an approach detecting unit that detects that the designating object enters within a predetermined distance of the display panel, wherein

the display control unit rearranges the plurality of screen components when the designating object enters within the predetermined distance of the display panel.

The 3^{rd} aspect of the present invention is the input device according to the 2^{nd} aspect of the present invention, wherein

the trajectory detecting unit includes a capacitance panel disposed on the display panel and a trajectory calculating unit that computes a trajectory based on output from the capacitance panel, and

the approach detecting unit detects the entering based on output from the capacitance panel.

The 4^{th} aspect of the present invention is the input device according to the 2^{nd} aspect of the present invention, wherein

the trajectory detecting unit detects the trajectory by performing sampling at a predetermined sampling interval, and

the direction estimating unit estimates the direction in which the designating object is going to move from a position where the entering of the designating object is detected by the approach detecting unit and a position where the designating object is detected by the trajectory detecting unit immediately prior to the detection of the entering.

The 5^{th} aspect of the present invention is the input device according to the 2^{nd} aspect of the present invention, wherein

the trajectory detecting unit detects the trajectory by performing sampling at a predetermined sampling interval, and

the direction estimating unit estimates the direction in which the designating object is going to move from a position where the entering of the designating object is detected by the approach detecting unit and a plurality of positions where the designating object is detected by the trajectory detecting unit before the detection of the entering.

The 6^{th} aspect of the present invention is the input device according to the 1^{st} aspect of the present invention, wherein

the display control unit rearranges the plurality of screen components so as to form a fan shape that spreads wider in the estimated direction from the side of the designating object.

The 7^{th} aspect of the present invention is the input device according to the 1^{st} aspect of the present invention, wherein

each of the plurality of screen components is assigned a priority beforehand, and

the display control unit rearranges the plurality of screen components such that the higher a priority of a screen component is, the nearer to the designating object the screen component is arranged.

The 8^{th} aspect of the present invention is the input device according to the 1^{st} aspect of the present invention, wherein

the display control unit rearranges the plurality of screen components on the side of the estimated direction of the designating object.

The 9^{th} aspect of the present invention is the input device according to the 1^{st} aspect of the present invention, wherein

the display control unit rearranges the plurality of screen components so as to be three-dimensionally displayed.

the 10^{th} aspect of the present invention is the input device according to the 9^{th} aspect of the present invention, wherein

the display panel three-dimensionally displays the plurality of screen components.

The 11^{th} aspect of the present invention is the input device according to the 8^{th} aspect of the present invention, wherein

the trajectory detecting unit three-dimensionally detects a trajectory of the designating object, and

the display control unit rearranges the plurality of screen components in a vicinity of an intersection of the estimated direction and the display panel.

The 12^{th} aspect of the present invention is an input method comprising:

a display step of displaying a plurality of screen components on a display panel;

a trajectory detecting step of detecting a trajectory of movement of a designating object for selecting the screen components;

a direction estimating step of estimating a direction in which the designating object is going to move, from the trajectory;

a rearrangement step of rearranging the plurality of screen components based on the estimated direction; and

a selection detecting step of detecting that one of the screen components is selected by the designating object.

The 13^{th} aspect of the present invention is a program embodied on a non-transitory computer-readable medium, the program causing a computer to execute the input method according to the 12^{th}.

### BRIEF DESCRIPTION OF THE DRAWINGS

FIG. 1 is a front configuration diagram of an input device according to a first embodiment of the present invention;

FIG. 2 is a cross-sectional configuration diagram of the input device according to the first embodiment of the present invention;

FIG. 3 is a front configuration diagram of a capacitance panel according to the first embodiment of the present invention;

FIG. 4 is an overall configuration diagram of the input device according to the first embodiment of the present invention;

FIG. 5 is a control flow diagram of the input device according to the first embodiment of the present invention;

FIGS. 6(A) and 6(B) are side configuration diagrams illustrating a state where a finger approaches an input device according to an embodiment of the present invention;

FIG. 7 is a front configuration diagram of a displaying unit of the input device according to the first embodiment of the present invention;

FIG. 8 is a front configuration diagram of the displaying unit of the input device according to the first embodiment of the present invention;

FIG. 9 is a front configuration diagram of the displaying unit of the input device according to the first embodiment of the present invention;

FIG. 10 is a front configuration diagram of a displaying unit for describing a method of estimating a direction that a finger is going to move in an input device according to a second embodiment of the present invention;

FIG. 11 is a control flow diagram of the input device according to the second embodiment of the present invention;

FIG. 12 is a front configuration diagram for describing a modification of a rearrangement of icons on the display units of the input device according to the first and second embodiments of the present invention;

FIG. 13 is a front configuration diagram for describing a modification of a rearrangement of icons on the display units of the input device according to the first and second embodiments of the present invention;

FIG. 14 is a front configuration diagram for describing a modification of a rearrangement of icons on the display units of the input device according to the first and second embodiments of the present invention;

FIG. 15 is a front configuration diagram for describing a modification of a rearrangement of icons on the display units of the input device according to the first and second embodiments of the present invention;

FIG. 16 is a side configuration diagram for describing a modification of a method of estimating a direction that a finger is going to move in the input device according to the first and second embodiments of the present invention;

FIG. 17 is a side configuration diagram illustrating a state where a finger approaches an input device according to a third embodiment of the present invention;

FIG. 18 is a side configuration diagram illustrating a state where icons are three-dimensionally displayed in the input device according to the third embodiment of the present invention;

FIG. 19 is a side configuration diagram illustrating a state where icons are three-dimensionally displayed in the input device according to the third embodiment of the present invention;

FIG. 20 is a side configuration diagram illustrating a state where a three-dimensionally displayed icon is selected in the input device according to the third embodiment of the present invention;

FIG. 21(A) is a perspective configuration diagram illustrating a state where a building is three-dimensionally displayed in an input device according to a fourth embodiment of the present invention, and FIG. 21(B) is a perspective configuration diagram illustrating a state where a finger approaches a three-dimensionally displayed building in the input device according to the fourth embodiment of the present invention;

FIG. 22 is a side configuration diagram illustrating a state where a finger approaches a three-dimensionally displayed building in the input device according to the fourth embodiment of the present invention;

FIG. 23 is a side configuration diagram illustrating a state where display parts representing respective floors are rearranged in the input device according to the fourth embodiment of the present invention;

FIG. 24 is a perspective configuration diagram illustrating a state where existing tenants of a selected floor are displayed in the input device according to the fourth embodiment of the present invention;

FIG. 25 is a front configuration diagram illustrating a two-dimensionally displayed building in a modification of the input device according to the fourth embodiment of the present invention;

FIG. 26(A) is a front configuration diagram illustrating a state where a finger approaches in a modification of the input device according to the fourth embodiment of the present invention, and FIG. 26(B) is a perspective configuration diagram illustrating a state where screen components are rearranged so as to be three-dimensionally displayed in the modification of the input device according to the fourth embodiment of the present invention;

FIG. 27 is a perspective configuration diagram illustrating a state where icons are three-dimensionally displayed in a modification of the input device according to the third embodiment of the present invention; and

FIG. 28 is a perspective configuration diagram illustrating a state where icons are rearranged in a modification of the input device according to the third embodiment of the present invention.

### DESCRIPTION OF SYMBOLS

10 input device
11 displaying unit
12 (12a, 12b, 12c, 12d, 12e, 12f) icon
13 display panel
14 capacitance panel
15 capacitance detecting unit
16 capacitance sampling unit
17 trajectory calculating unit
18 image processing unit
19 screen component creating unit
20 icon information memory unit
30 finger
21 image display control unit
22 protective cover
22a display screen
23 direction estimating unit
24 selection detecting unit
25 coordinate memory unit
131 liquid crystal layer
132 backlight
141 first electrode
142 second electrode
143 dielectric layer
144 (144a, 144b, 144c, 144d) detection point
154c, 154d detection point

### PREFERRED EMBODIMENTS OF THE INVENTION

Hereinafter, embodiments of the present invention will now be described.

### First Embodiment

An input device according to a first embodiment of the present invention will now be described.

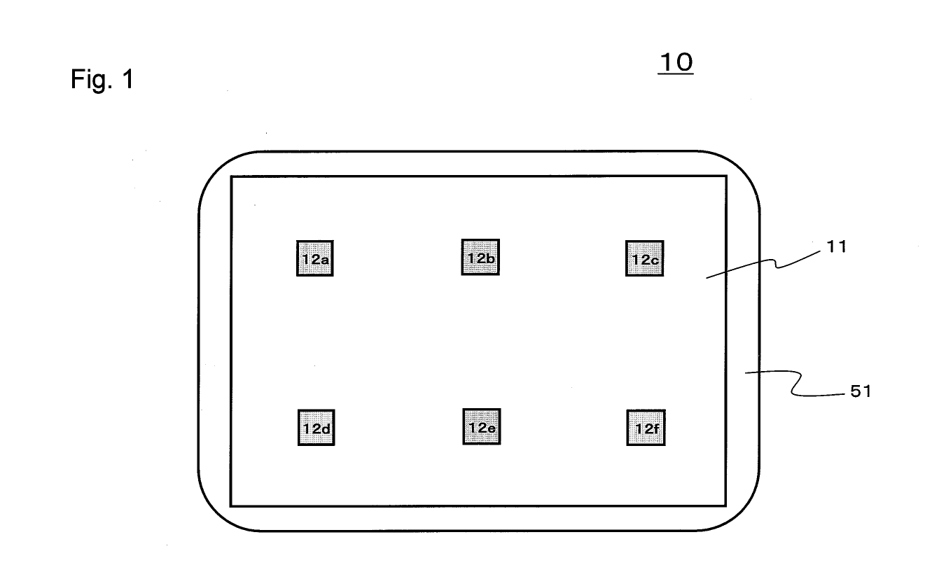

FIG. 1 is a front configuration diagram of an input device according to the first embodiment of the present invention. As illustrated in FIG. 1, an input device 10 according to the present first embodiment includes a displaying unit 11 at the center thereof. A periphery of the displaying unit 11 with the exception of the surface thereof is covered by a cover portion 51. A plurality of icons (icons 12a, 12b, 12c, 12d, 12e and 12f) are displayed on the displaying unit 11. In this case, an icon refers to a pictogram which is used in a GUI (Graphical User Interface) environment and which is designed such that a type of an application or a file is self-explanatory.

While the icons 12 are used as an example in the present first embodiment, objects to be displayed on a screen such as a thumbnail, a reduced image, a character, or a character string that represent a part of a content will be collectively referred to as screen components. A configuration can be adopted in which screen components appear in the displaying unit 11.

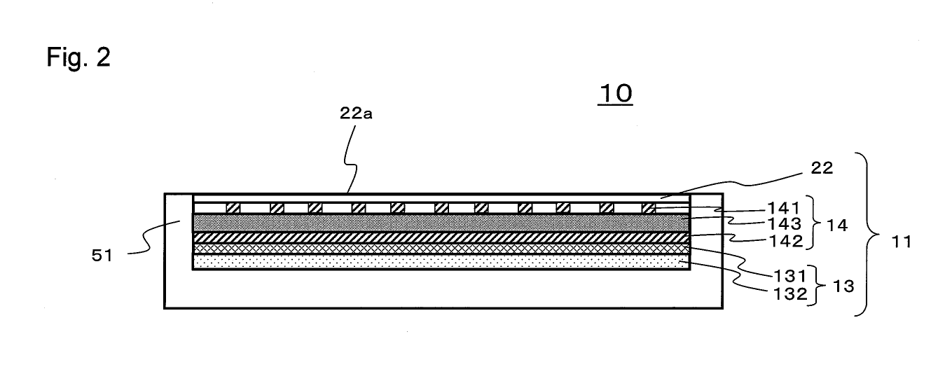

FIG. 2 is a cross-sectional configuration diagram of the input device 10 according to the present first embodiment. As illustrated in FIG. 2, the displaying unit 11 of the input device 10 includes a display panel 13, a capacitance panel 14 arranged on an upper side of the display panel 13, and a protective cover 22 arranged on an upper side of the capacitance panel 14. A surface of the protective cover 22 becomes a display screen 22a on which a user confirms images by sight.

The display panel 13 includes a liquid crystal layer 131 and a backlight 132 that illuminates the liquid crystal layer 131.

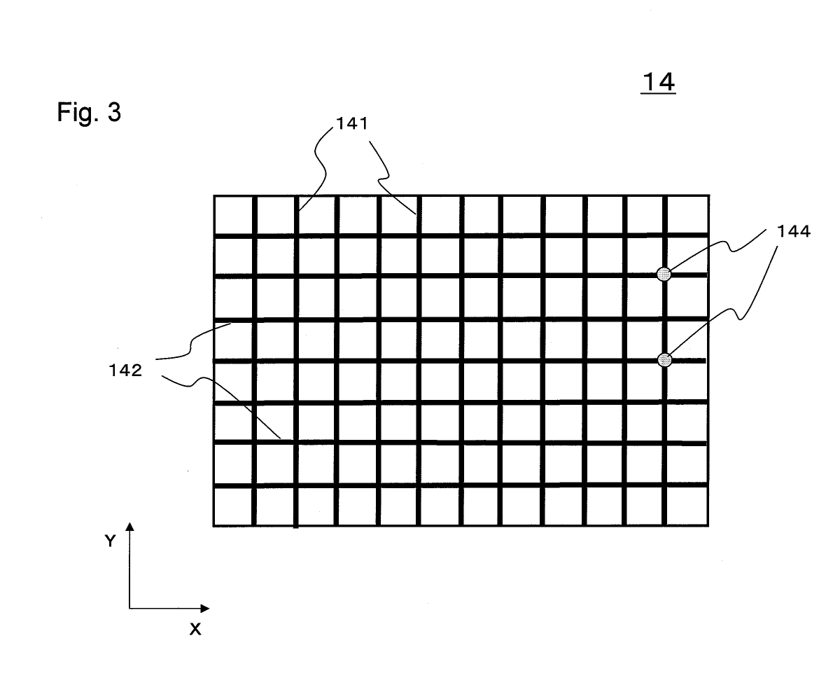

FIG. 3 is a front configuration diagram of the capacitance panel 14. Let us now assume that upward in the diagram represents the positive direction on a y-axis and rightward in the diagram represents the positive direction on an x-axis. As illustrated in FIG. 3, on the capacitance panel 14, a plurality of linearly-formed first electrodes 141 parallel to each other are arranged parallel to the y-axis in the drawing and a plurality of linearly-formed second electrodes 142 parallel to each other are arranged parallel to the x-axis in the drawing.

In addition, as illustrated in FIG. 2, a dielectric layer 143 is sandwiched between the first electrode 141 and the second electrode 142. As illustrated in FIG. 3, a plurality of detection points 144 arranged in a grid-like pattern are formed by the first electrodes 141 and the second electrodes 142.

As described above, the capacitance panel 14 that uses a capacitance method is adopted in the input device 10 according to the present first embodiment. By detecting a capacitance variation at each detection point 144, the capacitance panel 14 is able to detect a finger existing proximal to, approaching, separating from, or touching the capacitance panel 14.

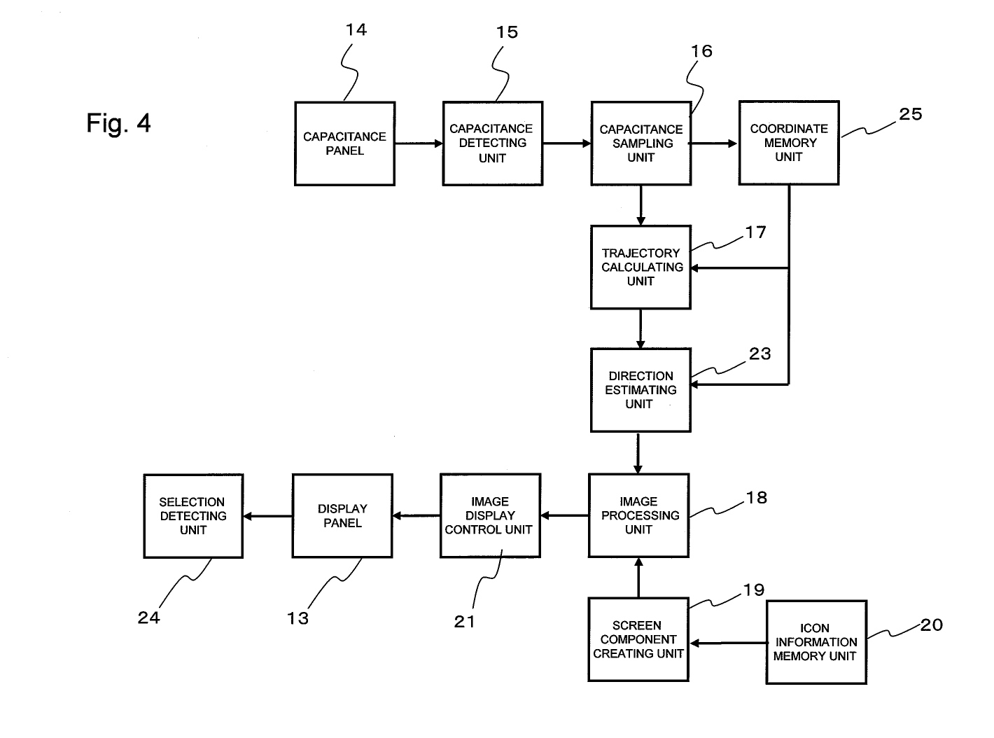

FIG. 4 is a block diagram of an overall configuration of the input device 10 according to the present first embodiment. As illustrated in FIG. 4, the input device 10 according to the present first embodiment includes: the capacitance panel 14; a capacitance detecting unit 15 that detects capacitance at all detection points 144 of the capacitance panel 14; a capacitance sampling unit 16 that causes the capacitance detecting unit 15 to detect capacitance at each constant sampling period until a maximum variation among detected capacitance variations exceeds a predetermined reference value; a coordinate memory unit 25 that saves coordinates of a detection point 144 at which is detected the maximum variation among the capacitance variations detected by the capacitance sampling unit 16; a trajectory calculating unit 17 that calculates a trajectory of a finger from the detection point 144 detected by the capacitance sampling unit 16; and a direction estimating unit 23 that estimates a direction in which a finger is going to move based on the calculated trajectory.

Additionally provided are: an icon information memory unit 20 that stores information regarding priorities of the plurality of icons 12 displayed on the liquid crystal layer 131; a screen component creating unit 19 that creates the icons 12 to be displayed on the liquid crystal layer 131; and an image processing unit 18 that arranges the icons 12 created by the screen component creating unit 19 based on the direction estimated by the direction estimating unit 23 and priorities of the respective icons 12. Furthermore, an image display control unit 21 is provided that displays an arrangement of the icons 12 created by the image processing unit 18 on the display panel 13.

Moreover, a selection detecting unit 24 is provided which detects that an icon 12 among the plurality of icons 12 is touched and selected by the finger.

Moreover, an example of a display panel according to the present invention corresponds to the display panel 13 according to the present embodiment, and an example of a trajectory detecting unit according to the present invention corresponds to the capacitance panel 14, the capacitance detecting unit 15, the capacitance sampling unit 16, the trajectory calculating unit 17, and the coordinate memory unit 25 according to the present embodiment. In addition, an example of the direction estimating unit according to the present invention corresponds to the direction estimating unit 23 according to the present embodiment, and an example of a display control unit according to the present invention corresponds to the image processing unit 18, the screen component creating unit 19, the icon information memory unit 20, and the image display control unit 21 according to the present embodiment. Furthermore, an example of a selection detecting unit according to the present invention corresponds to the selection detecting unit 24 according to the present embodiment. Moreover, an example of an approach detecting unit according to the present invention corresponds to the capacitance panel 14, the capacitance detecting unit 15, and the capacitance sampling unit 16 according to the present embodiment.

Next, operations performed by the input device according to the present embodiment will be described together with an example of an input method according to the present invention.

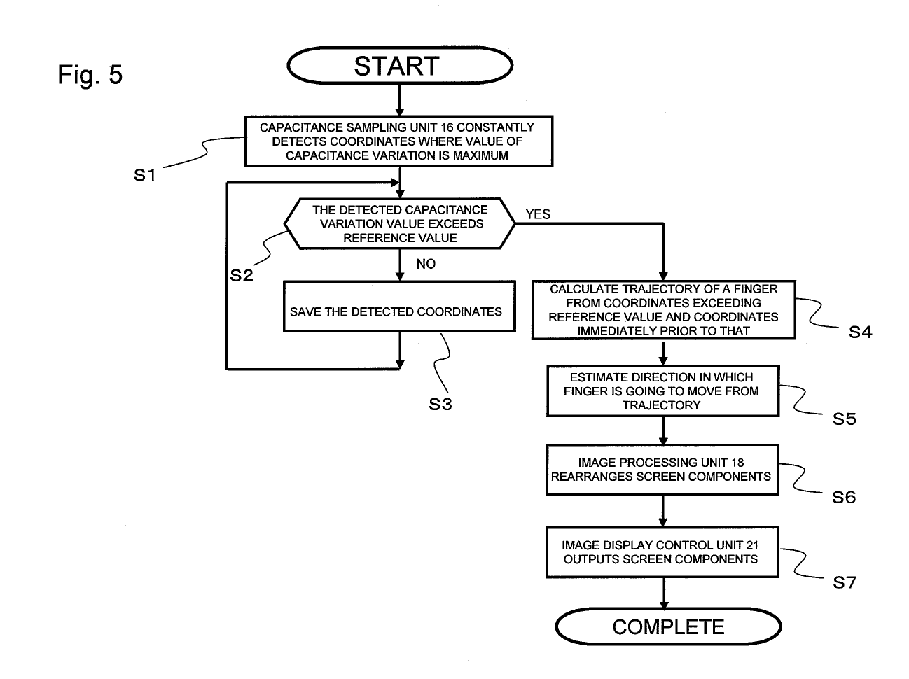

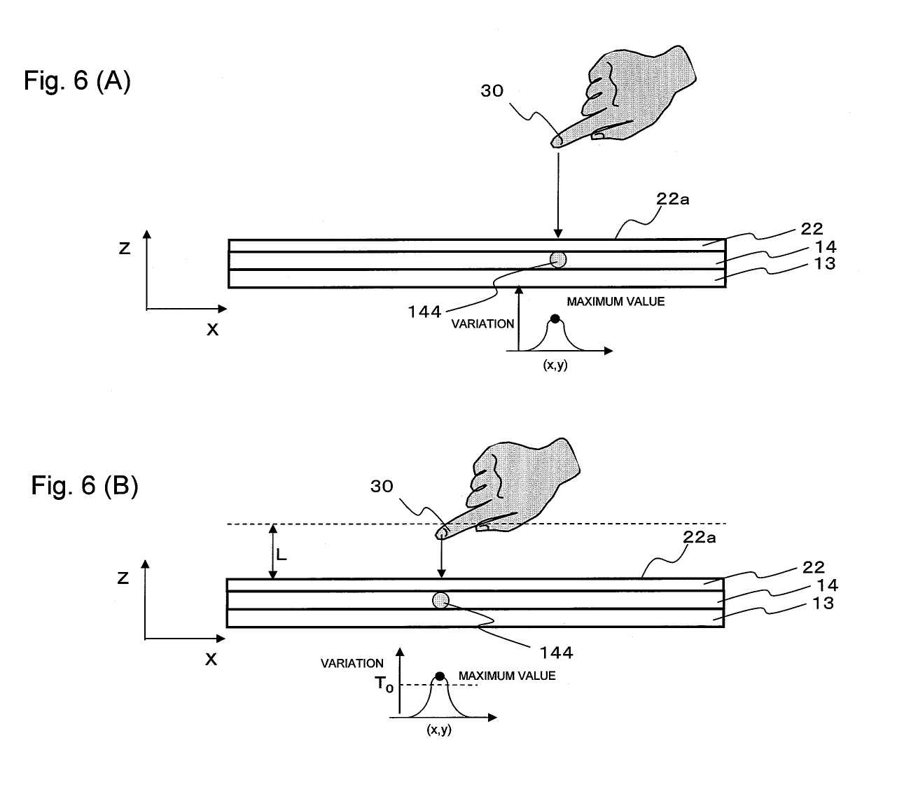

FIG. 5 is a control flow diagram of the input device according to the present embodiment. In addition, FIGS. 6(A) and 6(B) are side configuration diagrams illustrating a state where a finger approaches the input device according to the present embodiment. It should be noted that the cover portion 51 (refer to FIG. 1) covering the displaying unit 11 is omitted in FIGS. 6(A) and 6(B) (the same applies to subsequent drawings). In the drawings, it is assumed that vertically upward with respect to the display screen 22a represents a positive direction in a z-axis.

For example, after power is turned on, icons 12a, 12b, 12c, 12d, 12e and 12f arranged as illustrated in FIG. 1 are displayed. This corresponds to an example of a display step according to the present invention.

With the input device 10 according to the present embodiment, as indicated by reference character S1 in FIG. 5, the capacitance sampling unit 16 causes the capacitance detecting unit 15 to constantly detect capacitance variations at all detection points 144 at a predetermined sampling period. In addition, at each sampling period, the coordinates of a detection point 144 having a maximum capacitance variation are detected. As illustrated in FIG. 6(A), as a finger 30 approaches the display screen 22a, capacitance variation becomes maximum at a detection point 144 existing nearest to a line drawn vertically from the finger 30 to the capacitance panel 14. Therefore, the XY coordinates of a position where the finger 30 exists can be detected from the XY coordinates of the detection point 144 where capacitance variation becomes maximum. Moreover, a graph illustrated below the detection point 144 is a graph representing a state where the capacitance variation becomes maximum at the detection point.

In addition, in S2 in FIG. 5, when the detected maximum variation does not exceed a preset reference value, control proceeds to S3 and coordinates of the detection point 144 where the maximum variation is detected are saved in the coordinate memory unit 25.

While control once again proceeds to S2 after S3, when it is once again judged in S2 that the detected maximum variation does not exceed the preset reference value, the coordinates of a newly detected detection point having maximum variation are also saved in the coordinate memory unit 25. In this manner, a trajectory of the finger 30 is detected as positions in an XY coordinate system.

On the other hand, when it is judged in S2 that the detected maximum variation exceeds the preset reference value, control proceeds to S4. In this case, the reference value refers to a value indicating that the finger 30 enters the display screen 22a of the input device 10 to within a predetermined distance. In other words, since the closer the finger 30 is to the capacitance panel 14, the greater the capacitance variation, the entering of the finger 30 in the z-direction to within a predetermined distance of the capacitance panel 14 can be detected by providing the reference value. For example, as illustrated in FIG. 6(B), the entering of the finger 30 in the z-direction within a distance L of the display screen 22a can be detected. In this case, a graph illustrated below the detection point 144 is a graph representing a state where the capacitance variation at the detection point 144 at which maximum variation is detected equals or exceeds a reference value T₀. Moreover, an example of detecting an approach to within a predetermined distance according to the present invention corresponds to detecting an entering within the distance L of the display screen 22a according to the present embodiment.

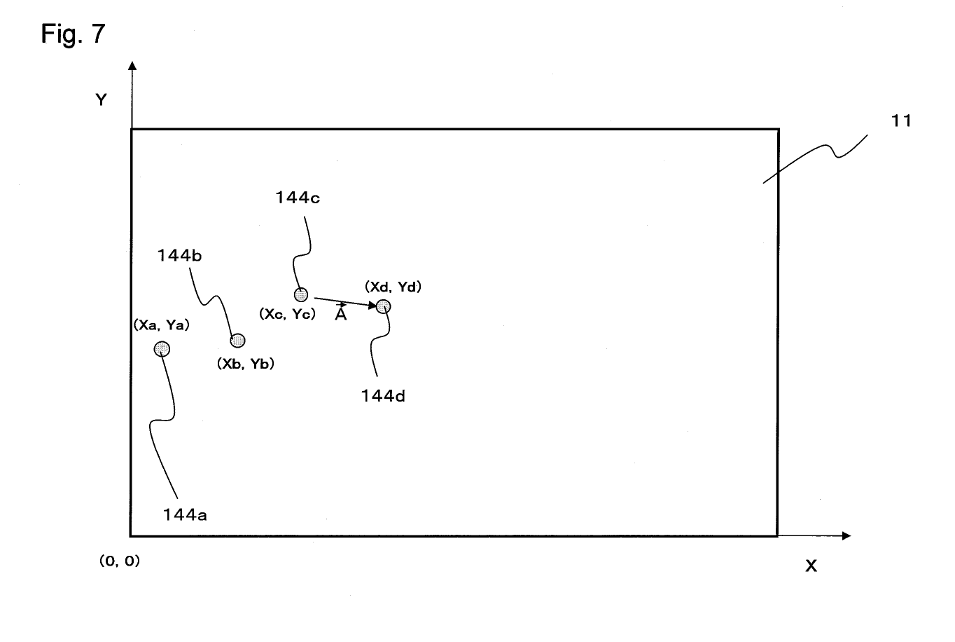

Subsequently, in S4, the trajectory calculating unit 17 calculates a trajectory of the finger 30 from an XY coordinate position of a detection point where capacitance variation is judged to exceed the reference value (hereinafter also referred to as a final detection point) and an XY coordinate position of the detection point 144 where a maximum variation is detected during an immediately previous sampling. Specifically, a vector is calculated from the coordinates of the two positions. FIG. 7 is a front view of the capacitance panel 14. FIG. 7 illustrates a plurality of detection points 144 where capacitance variation is maximum, the detection points 144 being denoted as 144a, 144b, 144c, and 144d in chronological order. In other words, reference character 144a denotes a detection point detected earliest and 144d denotes the final detection point. Assuming that the bottom-left corner of the displaying unit 11 in the drawing represents an origin (0, 0) and the respective XY coordinates of the detection points 144a, 144b, 144c, and 144d are (Xa, Ya), (Xb, Yb), (Xc, Yc), and (Xd, Yd), it is revealed that the finger 30 moves describing this trajectory and enters within the predetermined distance L of the capacitance panel 14 at (Xd, Yd).

At this point, the trajectory calculating unit 17 calculates a vector A (Xd−Xc, Yd−Yc) from the position (Xc, Yc) to the position (Xd, Yd). S1 to S4 correspond to an example of a trajectory detecting step according to the present invention.

In S5, using the calculated vector A, the direction estimating unit 23 estimates a direction in which the finger 30 is going to move. In other words, the direction estimating unit 23 estimates that the finger 30 is going to further move by the vector A from the position of the detection point 144d (Xd, Yd) that is the final detection point, and identifies coordinates reached by a movement by the vector A from the position of the coordinates (Xd, Yd). In this case, the identified coordinates are (2Xd−Xc, 2Yd−Yc). S5 corresponds to an example of a direction estimating step according to the present invention. In addition, an example of a position where an entering of a designating object is detected according to the present invention corresponds to the coordinates (Xd, Yd) according to the present embodiment, and an example of a position where the designating object is detected by the trajectory detecting unit immediately prior to the detection of the entering according to the present invention corresponds to the coordinates (Xc, Yc) according to the present embodiment.

Subsequently, in S6, the image processing unit 18 rearranges screen components such as the icons 12a, 12b, 12c, 12d, 12e, and 12f based on the identified coordinates (2Xd−Xc, 2Yd−Yc) and the vector A. S6 corresponds to an example of a rearrangement step according to the present invention.

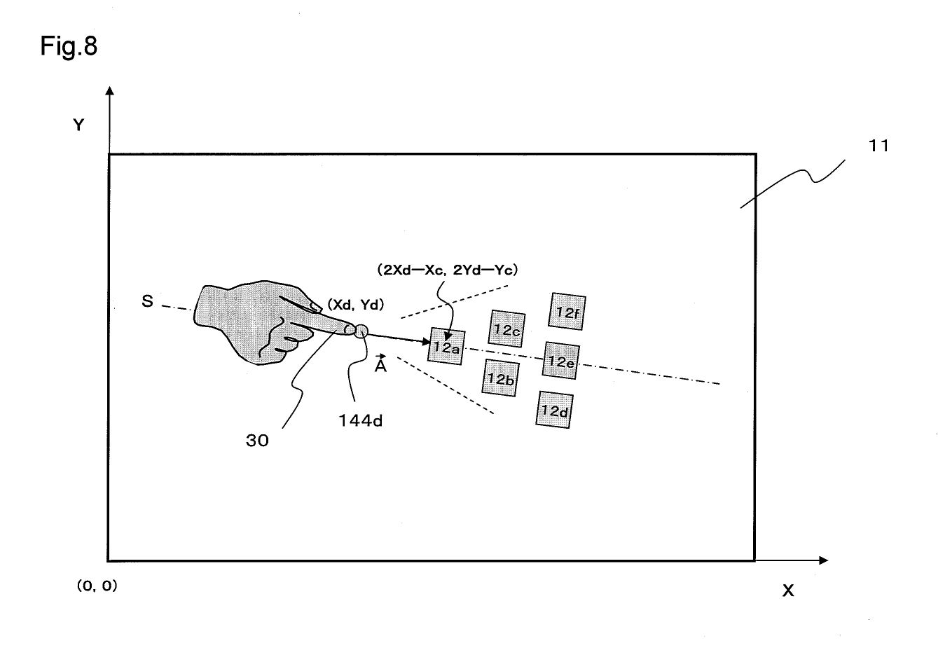

Finally, in S7, the image display control unit 21 displays the rearranged screen components on the display panel 13. FIG. 8 is a front view of the displaying unit 11 illustrating a state where the icons 12a, 12b, 12c, 12d, 12e, and 12f are rearranged. As illustrated in FIG. 8, with reference to the finger 30, the icons 12a, 12b, 12c, 12d, 12e, and 12f are arranged on a side of an estimated direction in which the finger 30 is going to move in a fan shape that becomes wider when proceeding in the direction. The icons 12a, 12b, 12c, 12d, 12e, and 12f are displayed on the display panel 13 arranged in an order of priority recorded in the icon information memory unit 20 on a side nearer to the finger 30. In other words, in the present first embodiment, the icon 12a has the highest priority, followed in sequence by the icons 12b and 12c, and then the icons 12d, 12e, and 12f. Priorities may be arbitrarily set by the user or automatically set such that the greater the number of times an icon is selected by the user, the higher the priority of the icon.

More specifically, the icon 12a having the highest priority is arranged such that the center of the icon 12a is positioned at the coordinates (2Xd−Xc, 2Yd−Yc) identified by the direction estimating unit 23, and using a line connecting the final detection point and the icon 12a as a central line (in the diagram, the dashed-dotted line S), the icons 12b, 12c, 12d, 12e, and 12f are arranged in a fan shape.

Subsequently, for example, when the icon 12a among the plurality of icons 12 arranged in a fan shape is touched by the finger 30, the selection detecting unit 24 detects that the icon 12a is selected and an application assigned to the icon 12a is activated. A step for detecting the selection of the icon 12a in this manner corresponds to an example of a selection detecting step according to the present invention. A contact threshold for detecting contact is set in advance, whereby contact by the finger 30 is detected when capacitance variation equals or exceeds the contact threshold. The capacitance variation at the contact threshold is set to a value greater than the reference value for detecting that the finger 30 enters within a distance L of the display screen 22a.

As described above, in the present embodiment, since a direction in which the finger 30 is going to move is estimated and icons are displayed in a descending order of priority on the side of the direction before the user touches the displaying unit, the user can promptly select a desired icon and greater operability is achieved.

In addition, in the present embodiment, since icons are rearranged on the side of the direction in which the finger 30 is going to move, the user need not closely study the display screen. Therefore, the use of the input device according to the present invention in a car navigation system enables the user to look away from the display screen as much as possible and safer driving can be realized.

Moreover, as illustrated in FIG. 6(B), even when after the finger 30 temporarily enters within the distance L of the display screen 22a, the plurality of icons 12 is rearranged as illustrated in FIG. 8, and the finger 30 then separates from the display screen 22a to beyond the distance L, the display state of the arrangement illustrated in FIG. 8 is maintained. Subsequently, when the finger 30 approaches the display screen 22a from a different direction and enters within the distance L of the display screen 22a, the plurality of icons 12 are rearranged based on the trajectory of the finger 30.

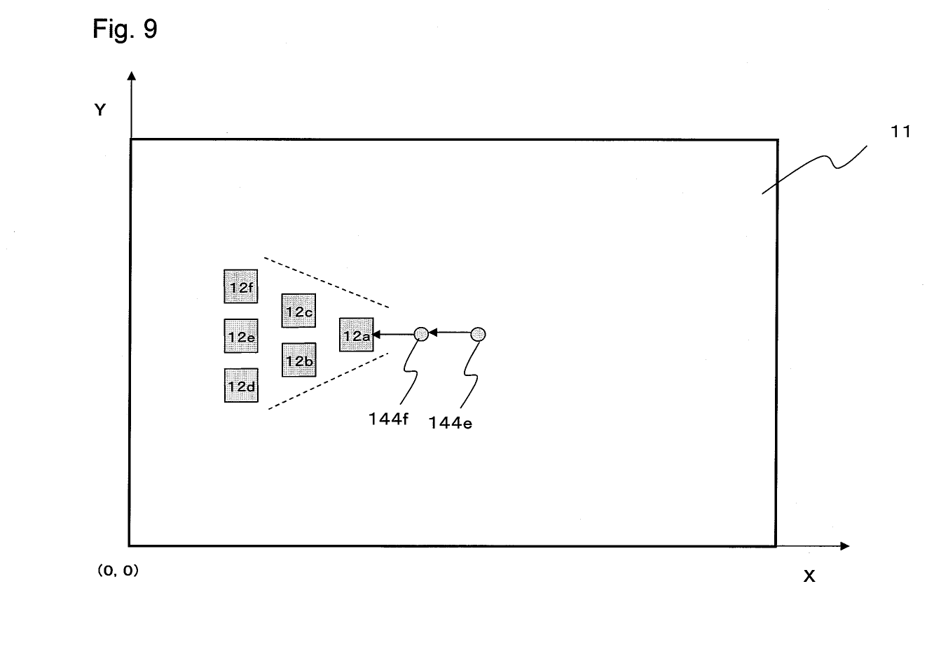

For example, when the finger 30 once again approaches the display screen 22a in a negative direction of the X-axis parallel to the X-axis, the icons 12a, 12b, 12c, 12d, 12e, and 12f are displayed rearranged from the arrangement state illustrated in FIG. 8 to a fan shape that spreads toward the negative direction of the X-axis as illustrated in FIG. 9. FIG. 9 illustrates a detection point 144f that is the final detection point and a detection point 144e where a maximum variation is detected during the immediately previous sampling.

In addition, in a case where after the icons 12 are rearranged as illustrated in FIG. 8, the finger 30 does not enter within the distance L of the display screen 22a within a predetermined amount of time, control may be performed so that the icons 12 are restored to the arrangement illustrated in FIG. 1 or the like.

Furthermore, in the present embodiment, while coordinates of all detection points having maximum variation are saved, since only the coordinates of two points, namely, the final detection point and the previous detection point, are to be used, old coordinates may be configured so as to be discarded when saving new coordinates.

Moreover, in the present embodiment, while a vector is calculated from two points, namely, the final detection point and the previous detection point, to estimate a direction in which the finger 30 is going to move, more previous detection points can be further included to obtain a vector sum of the plurality of detection points and estimate a direction in which the finger 30 is going to move from the vector sum.

In addition, in the present embodiment, while a position reached by a movement of vector A from the final detection point is used as the coordinates where the icon 12a having the highest priority is displayed, only the direction of movement may be set so as to coincide with vector A and the distance of movement from the final detection point may be set to a fixed distance.

### Second Embodiment

Next, an input device according to a second embodiment of the present invention will now be described. While the input device according to the present second embodiment is basically configured the same as that according to the first embodiment, methods of estimating a direction in which the finger 30 is going to move differ between the embodiments. Therefore, a description will be given focusing on this difference. Moreover, like components to the first embodiment are designated by like reference characters.

First, an overview of a method of estimating a direction in which the finger 30 is going to move with respect to an input device according to the present second embodiment will be described, followed by a detailed description with reference to a control flow.

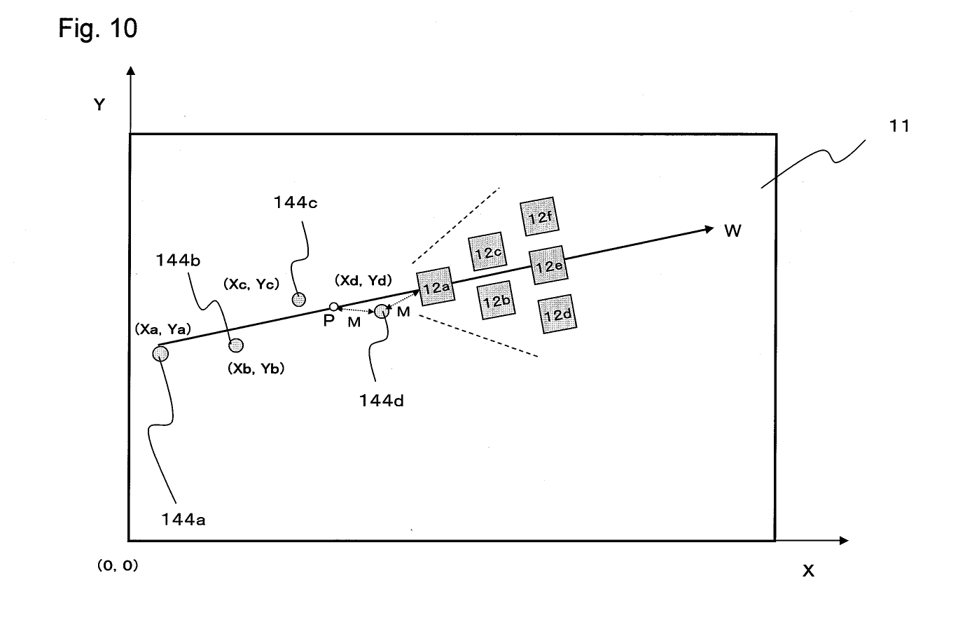

FIG. 10 is a front view of a displaying unit 11 for describing a method of estimating a direction in which the finger 30 is going to move with respect to an input device according to the present embodiment. FIG. 10 illustrates a trajectory of the finger 30 similar to that illustrated in FIG. 7 including detection points 144a, 144b, 144c, and 144d and respective coordinates (Xa, Ya), (Xb, Yb), (Xc, Yc), and (Xd, Yd) thereof. In the present second embodiment, an approximated straight line W (y=αx+b) is obtained from the coordinates using, for example, a least-square method, and icons 12a, 12b, 12c, 12d, 12e, and 12f are arranged in a fan shape centered at the approximated straight line W.

Next, a control flow of the input device according to the present second embodiment will be described.

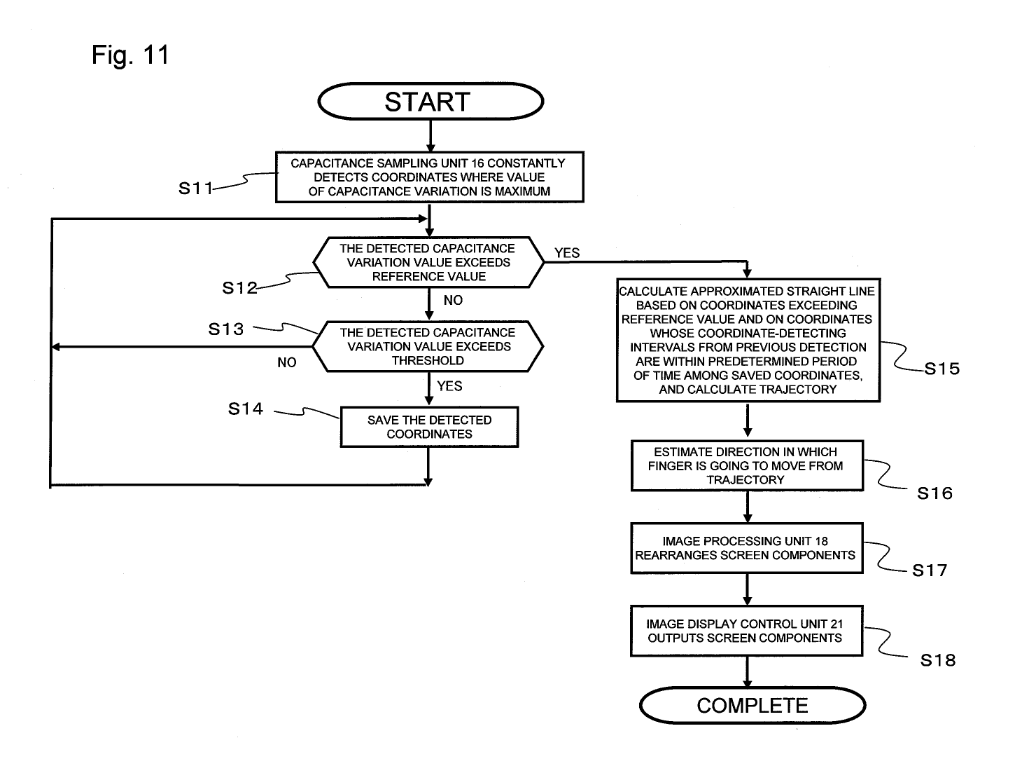

FIG. 11 is a diagram of a control flow of the input device according to the present second embodiment. As illustrated in FIG. 11, in S11, a capacitance sampling unit 16 causes a capacitance detecting unit 15 to constantly detect capacitance variations at all detection points 144 at a predetermined sampling period. In addition, at each sampling period, the coordinates of a detection point 144 having a maximum capacitance variation are detected.

In S12, when it is judged that the detected maximum variation does not exceed a preset reference value, control proceeds to S13.

In S13, a determination is made on whether or not the value of maximum variation detected by the capacitance sampling unit 16 exceeds a preset saved threshold. In this case, a saved threshold is a value set so as to prevent data of a detection point 144 at which a maximum value is detected due to noise or the like even when the finger 30 doesn't approach from being saved in a coordinate memory unit 25. Moreover, the saved threshold is a value smaller than the aforementioned reference value (to detect an entering within a distance L) and selection threshold (to detect touch), and values are set in an ascending order of magnitude of saved threshold, reference value, and selection threshold. In other words, an approach of the finger 30 to a display screen 22a can be recognized as capacitance variation sequentially exceeds the saved threshold, the reference value, and the selection threshold.

In S13, when the detected maximum variation exceeds the saved threshold, in S14, the coordinates of the detection point where the maximum variation is detected is saved in the coordinate memory unit 25.

On the other hand, when it is judged in S12 that the detected maximum variation exceeds a preset reference value, in S15, a trajectory calculating unit 17 calculates a trajectory of the finger 30. In this case, the trajectory of the finger 30 is calculated from the coordinates exceeding the reference value (the final detection point) and previously saved coordinates whose coordinate-detecting intervals are within a predetermined period of time among the saved coordinates. For example, in a case where coordinates (Xg, Yg), coordinates (Xa, Ya), coordinates (Xb, Yb), and coordinates (Xc, Yc) are saved in the coordinate memory unit 25 in chronological order and the coordinates of the final detection point are coordinates (Xd, Yd), when a detection interval between the coordinates (Xg, Yg) and the coordinates (Xa, Ya) is longer than a predetermined period of time and detection intervals between the other coordinates are shorter than the predetermined period of time, the coordinates (Xg, Yg) are not used as coordinates to calculate a trajectory. This is in assumption of a case where, for example, the user brings the finger 30 close to the display screen 22a in order to select an icon 12 and the existence of the finger 30 is detected and coordinates are saved in the coordinate memory unit 25 only to have the finger 30 move away from the display screen 22a to take care of other business. In other words, since the coordinates prior to moving the finger 30 away from the display screen 22a is configured so as not to be included in a computation for estimating a direction of the finger 30 when the user once again brings the finger 30 close to the display screen 22a after taking care of the other business, control is performed so as not to include previous detection points whose intervals equal or exceed a predetermined amount of time.

Subsequently, for example, assuming that the final detection point is the detection point 144d (Xd, Yd) illustrated in FIG. 10, an approximated straight line W is calculated using a least-square method from the four detection points 144, that is 144a (Xa, Ya), 144b (Xb, Yb), 144c (Xc, Yc), and 144d (Xd, Yd) illustrated in FIG. 10. S11 to S15 correspond to an example of a trajectory detecting step according to the present invention.

In S16, a direction estimating unit 23 estimates a direction on the approximated straight line W from the approximated straight line W and the detection point 144c immediately prior to the detection point 144d that is the final detection point, and estimates a direction in which the finger 30 is going to move, and identifies coordinates where an icon 12a having the highest priority is to be arranged.

Specifically, the direction estimating unit 23 estimates that the finger 30 is going to move on the approximated straight line W from the detection point 144d as a starting point in a separating direction from the previous detection point 144c. In addition, a position on the approximated straight line W separated from the final detection point by a predetermined distance (denoted by M in the drawing) can be assumed to be the coordinates where the icon 12a having the highest priority is to be arranged. Moreover, while two such points can be calculated, by removing the point nearer to the immediately previous detection point 144c (refer to P in the drawing), the coordinates where the icon 12a having the highest priority is to be arranged can be identified. In other words, arranged coordinates (X, Y) can be calculated by substituting Y=αX+β into (X−Xd)²+(Y−Yd)²=M² to obtain a solution of X. In this manner, the direction in which the finger 30 is going to move is estimated and the coordinates where the icon 12a is to be arranged is determined. S16 corresponds to an example of a direction estimating step according to the present invention. In addition, an example of a position where an entering of a designating object according to the present invention is detected corresponds to the coordinates (Xd, Yd) according to the present embodiment, and an example of a plurality of positions where the designating object is detected by the trajectory detecting unit before the detection of the entering according to the present invention corresponds to the coordinates (Xa, Ya), coordinates (Xb, Yb), and coordinates (Xc, Yc) according to the present embodiment.

Subsequently, in S17, arrangement coordinates of the respective icons 12 are determined by an image processing unit 18 based on the direction and coordinates estimated by the direction estimating unit 23 and rearrangement is performed. S17 corresponds to an example of a rearrangement step according to the present invention.

Specifically, the icon 12a is arranged at the coordinates identified by the direction estimating unit 23, and the other icons 12b, 12c, 12d, 12e, and 12f are arranged in a fan shape that gradually spreads toward the direction of movement estimated by the direction estimating unit 23 with the approximated straight line W as a center line.

Finally, in S18, the rearranged icons 12a, 12b, 12c, 12d, 12e and 12f are displayed on a display panel 13 by an image display control unit 21.

By performing control as described above, in the same manner as in the first embodiment, a direction in which the finger 30 is going to move can be estimated and icons can be displayed on the side of the direction in a descending order of priority.

Moreover, in the second embodiment, while the icon 12a is arranged at a position separated by a fixed distance M from the coordinates (Xd, Yd) of the final detection point, for example, the icon 12a may alternatively be arranged at a position separated from the coordinates (Xd, Yd) of the final detection point by a distance between the detection point 144d that is the final detection point and the immediately previous detection point 144c. In addition, the detection points 144a and 144b may be used in place of the detection point 144c.

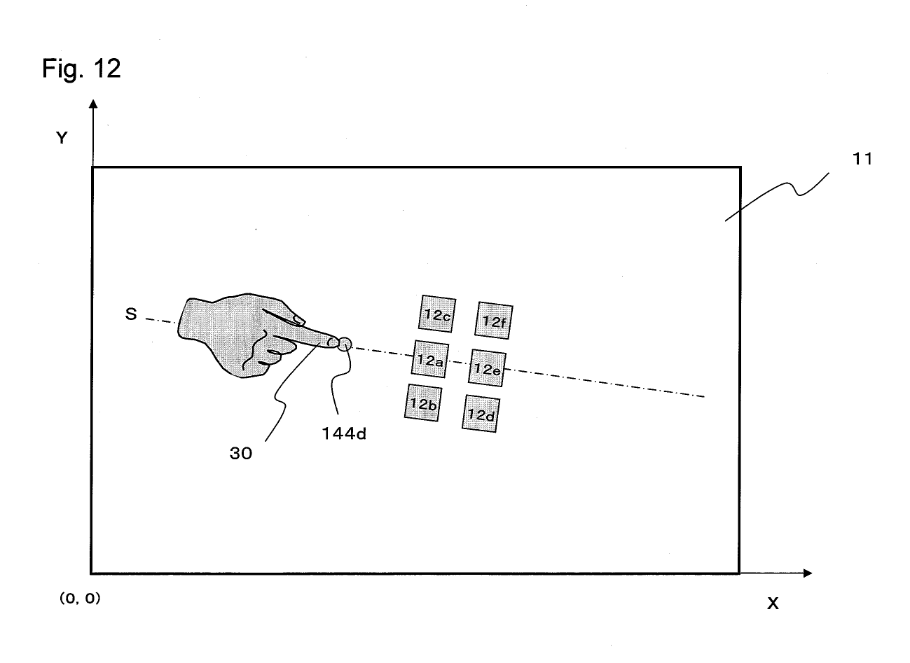

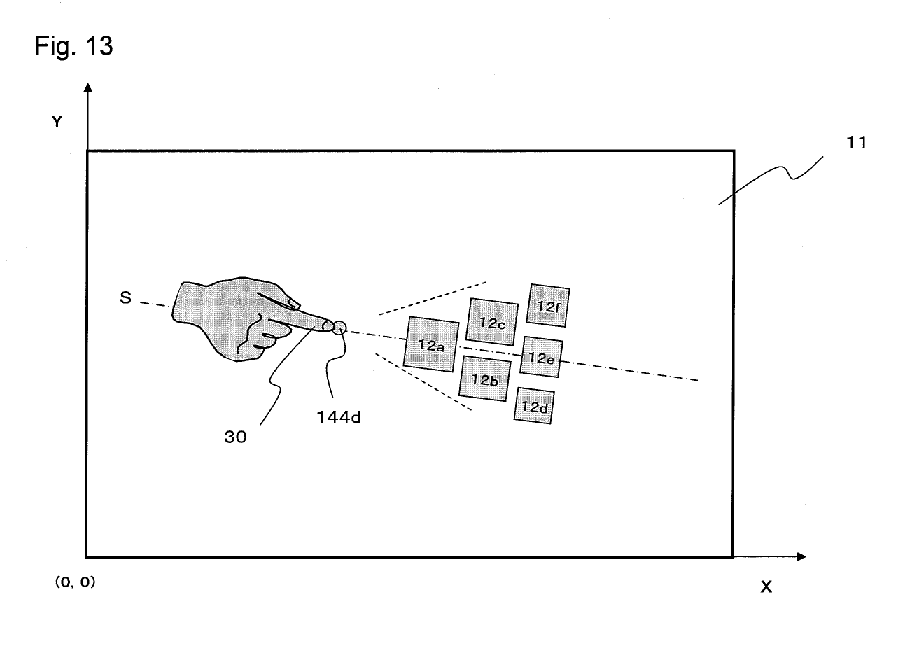

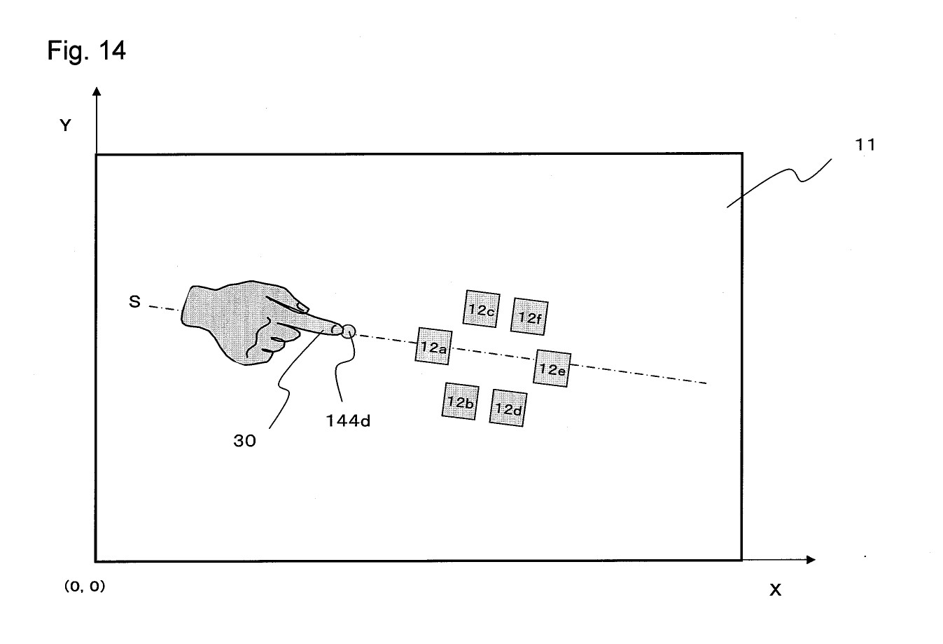

Furthermore, while a plurality of icons 12 are aligned and arranged in a fan shape in a descending order of priority in the first and second embodiments described above, the shape of arrangement is not limited to such a fan shape. For example, as illustrated in FIG. 12, a rectangular arrangement may be adopted. Even in this case, the icon with the highest priority is favorably arranged near the finger 30. In addition, as illustrated in FIG. 13, sizes of the icons 12 may be increased in a descending order of priority. In this case, the icon 12a is the largest and sizes decrease in an order of the icons 12b and 12c, and then the icons 12d, 12e, and 12f. Alternatively, only the icon with the highest priority may be displayed enlarged. In addition, an annular arrangement may be adopted as illustrated in FIG. 14. Even in this case, the icon 12a with the highest priority is favorably arranged near the finger 30. Furthermore, a linear arrangement along the estimated direction in a descending order of priority may be adopted. Moreover, while there are six icons 12 in the present embodiment, the number of icons is not limited to six.

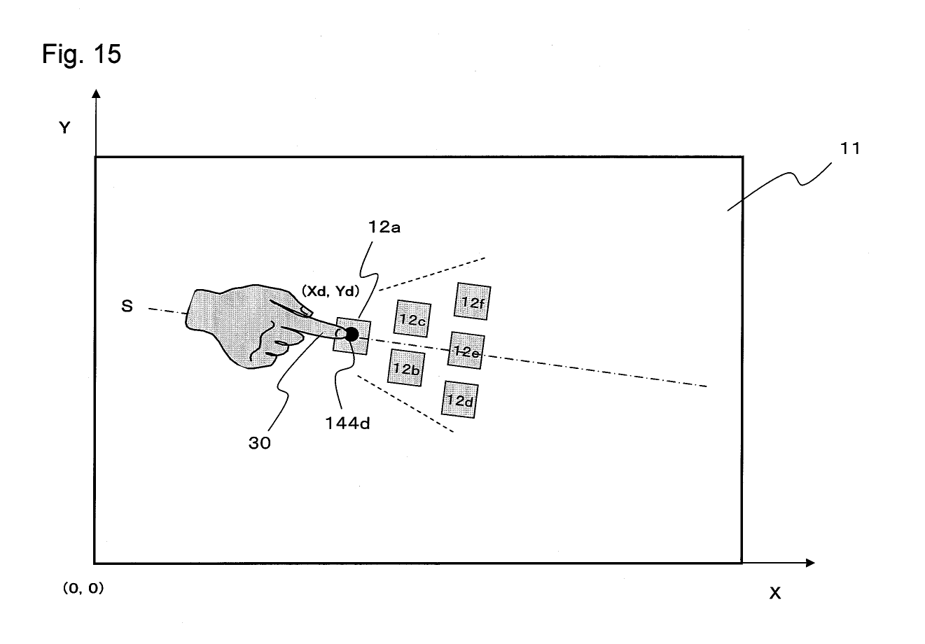

In addition, in the first and second embodiments, while the icon 12a is arranged at a position separated from the position of the final detection point by a predetermined distance, as illustrated in FIG. 15, the icon 12a may be arranged on the detection point 144d that is the final detection point. Moreover, the other icons 12b, 12c, 12d, 12e, and 12f are arranged in, for example, a fan shape along the estimated direction of movement of the finger 30.

Furthermore, while the screen component creating unit 19 newly creates icons in the embodiments described above, when icons are to be simply rearranged without enlargement or reduction, data of icons displayed prior to the rearrangement may be used without newly creating icons.

Moreover, while the icon 12 with the highest priority is arranged near the finger 30 in both of the embodiments described above, rearrangement may be performed regardless of priority. Even when rearrangement is performed regardless of priority, since the icons are rearranged toward a direction in which the finger 30 is going to move, an icon can be selected easier than a state where, for example, icons are randomly arranged as illustrated in FIG. 1.

In addition, in the first embodiment, a saved threshold similar to that of the second embodiment can be provided so that coordinates of a detection point are saved in the coordinate memory unit 25 only when maximum capacitance variation equals or exceeds the saved threshold.

Furthermore, in the embodiment described above while the detection of a trajectory of the finger 30 and an estimation of a direction in which the finger is going to move are triggered when variation exceeds a predetermined reference value, such control is not restrictive. Alternatively, for example, the detection of a trajectory of the finger 30 and an estimation of a direction in which the finger is going to move may be triggered when variations exceeding the saved threshold are consecutively detected a predetermined number of times after a variation exceeding the saved threshold is first detected.

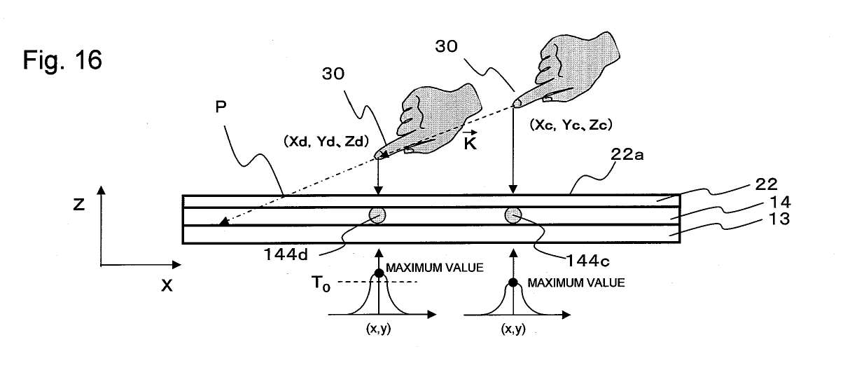

Moreover, while a direction in which the finger 30 is going to move is estimated two-dimensionally on an XY plane in the first and second embodiments described above, the estimation may alternatively be performed three-dimensionally. A description thereof will be given using the first embodiment as an example. FIG. 16 is a side configuration diagram illustrating a state where the finger 30 is approaching the display screen 22a. Assuming that the final detection point is the detection point 144d (coordinates (Xd, Yd, Zd)) and the previous detection point is the detection point 144c (coordinates (Xc, Yc, Zc)), a direction can be estimated based on a three-dimensional vector K (Xd−Xc, Yd−Yc, Zd−Zd). In addition, the icon 12a having the highest priority can be arranged in the vicinity of an intersection P of a straight line (indicated in the drawing by the dashed-dotted line) extended from the coordinates (Xd, Yd, Zd) in the direction of the vector K (indicated in the drawing by the dotted line) and the display screen 22a.

### Third Embodiment

Next, an input device according to a third embodiment of the present invention will now be described. While the input device according to the present third embodiment is basically configured the same as that according to the first embodiment, the present third embodiment differs from the first in that a trajectory along which a finger 30 moves is estimated three-dimensionally and icons are three-dimensionally displayed. Therefore, a description will be given focusing on this difference.

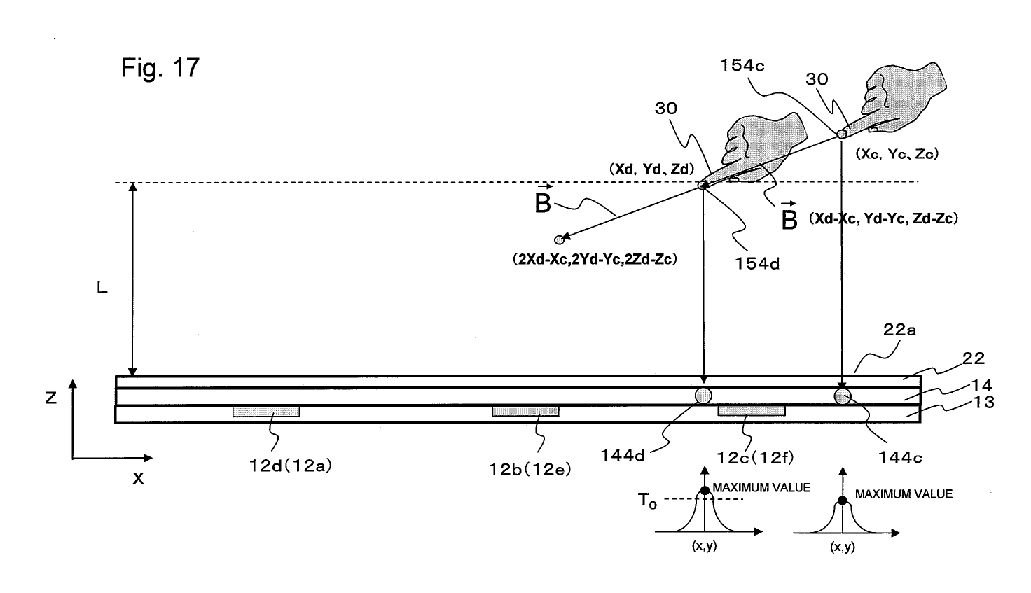

FIG. 17 is a side configuration diagram of an input device according to a third embodiment of the present invention. The display state of the icons 12a, 12b, 12c, 12d, 12e, and 12f is similar to the state illustrated in FIG. 1. In other words, before the finger 30 approaches the display screen 22a, the icons 12a, 12b, 12c, 12d, 12e and 12f are displayed on a plane.

In the same manner as in the first embodiment, when it is detected that the finger 30 enters within a distance L of the display screen 22a in a z-axis direction, the detection point is assumed to be a final detection point 154d. Subsequently, a trajectory of the finger 30 is calculated from positions in an XYZ coordinate system of the final detection point 154d (coordinates (Xd, Yd, Zd)) and a detection point 154c (coordinates (Xc, Yc, Zc)) where variation is detected so as to be maximum during an immediately previous sampling. Coordinates in the z-axis direction can be obtained from a maximum value of capacitance variations. In addition, positions of the detection point 154c and the final detection point 154d on a capacitance panel 14 are indicated as detection points 144c and 144d. Graphs illustrated below the detection points 144c and 144d are graphs indicating states where the capacitance variation becomes maximum at the detection points.

Specifically, a vector is calculated from the coordinates of the two positions by a trajectory calculating unit 17. In other words, the trajectory calculating unit 17 calculates a vector B from the position of the detection point 154c (Xc, Yc, Zc) to the position of the final detection point 154d (Xd, Yd, Zd).

Using the calculated vector B, a direction estimating unit 23 estimates a direction in which the finger 30 is going to move. In other words, the direction estimating unit 23 estimates that the finger 30 is going to move by the vector B from the position of the final detection point 154d (Xd, Yd, Zd) and identifies coordinates reached by a movement by the vector B from the position of the coordinates (Xd, Yd, Zd). In this case, the identified coordinates are (2Xd−Xc, 2Yd−Yc, 2Zd−Zc).

Subsequently, a screen component creating unit 19 creates a screen component based on information regarding priorities stored in an icon information memory unit 20. In this case, creating a screen component refers to creating, for example, a right-eye image and a left-eye image so as to three-dimensionally display a screen component. In addition, by appropriately creating a right-eye image and a left-eye image, a three-dimensional (stereographic) display can be presented as though floating above a display panel 13 by a predetermined distance. Moreover, the distance of the floating representation from the display screen 22a during the three-dimensional display is not altered by a distance between the display screen 22a and a point of view.

Subsequently, an image processing unit 18 rearranges screen components such as the icons 12a, 12b, 12c, 12d, 12e, and 12f based on the identified coordinates (2Xd−Xc, 2Yd−Yc, 2Zd−Zc) and the vector B.

The rearranged and three-dimensionally displayed icons 12a, 12b, 12c, 12d, 12e and 12f are displayed on a display panel 13 by an image display control unit 21.

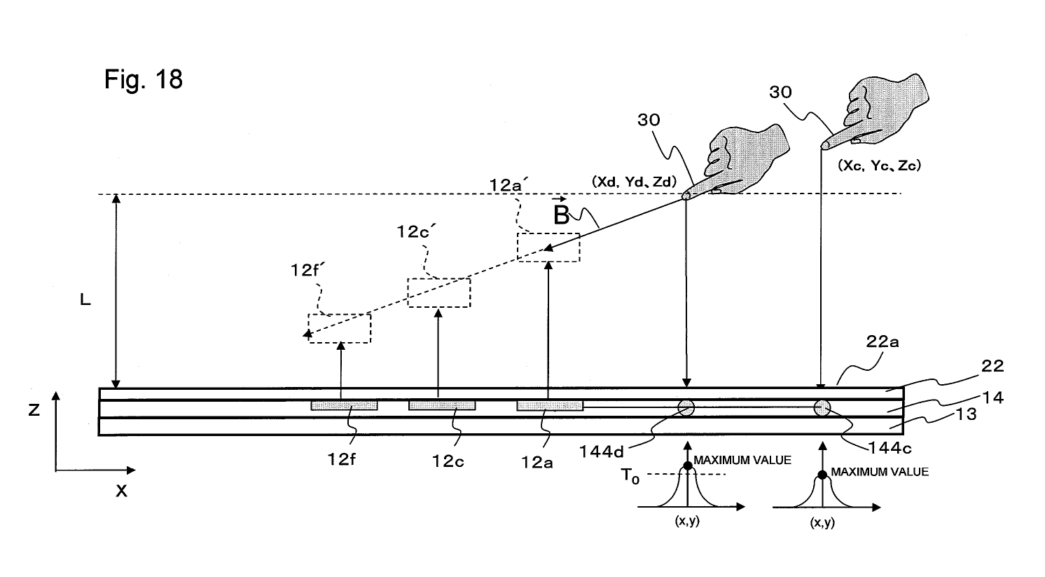

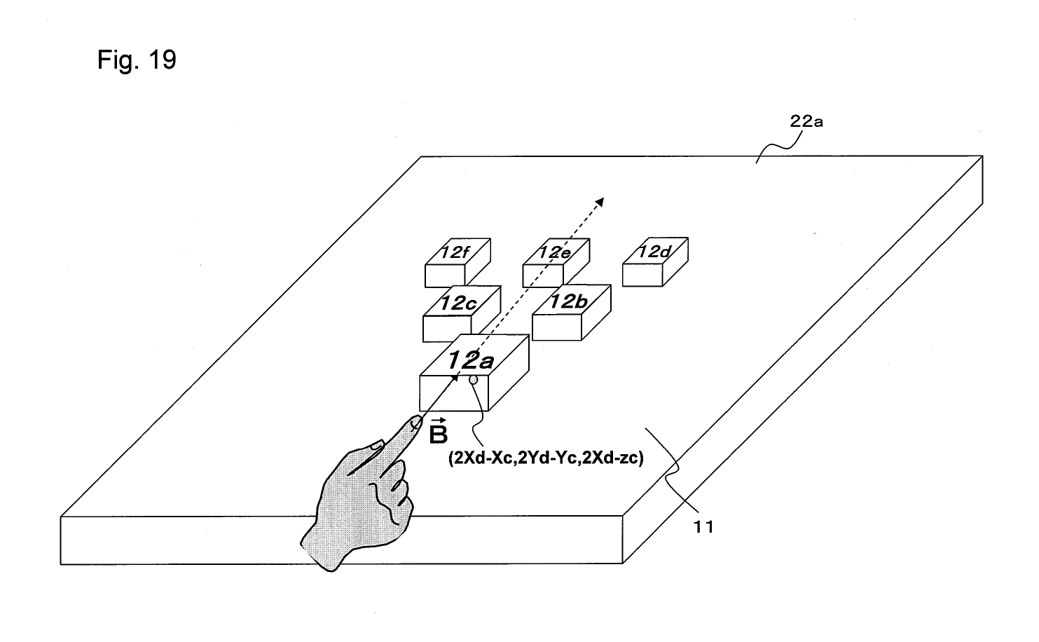

FIG. 18 is a side configuration diagram of the input device according to the present third embodiment in a state where screen components are rearranged so as to be three-dimensionally displayed. In FIG. 18, positions where the icons 12a, 12c, and 12f are to be respectively three-dimensionally displayed are indicated by dotted lines as icons 12a′, 12c′, and 12f′. In addition, FIG. 19 is a diagram illustrating a three-dimensionally displayed state of icons that the user confirm by sight in a state where screen components are rearranged in the input device according to the present third embodiment.

As illustrated in FIG. 18 and FIG. 19, in the input device according to the present third embodiment, when the finger 30 enters within a predetermined distance L of the display screen 22a, the icons 12a, 12b, 12c, 12d, 12e and 12f are not only arranged in a descending order of priorities thereof but also rearranged so as to be three-dimensionally displayed. The icon 12a has the highest priority, followed in sequence by the icons 12b and 12c, and then by the icons 12d, 12e, and 12f.

Therefore, the icon 12a is three-dimensionally displayed so as to be arranged on the identified coordinates (2Xd−Xc, 2Yd−Yc, 2Zd−Zc) and the other icons 12b, 12c, 12d, 12e and 12f are three-dimensionally displayed so as to be arranged in a fan shape having the direction of vector B as a center thereof. In other words, icons are displayed at positions near the finger 30 in a descending order of priority and the icons approach the display screen 22a in sequence starting from the icon 12a, followed by the icons 12b and 12c, and then by the icons 12d, 12e, and 12f. Since the icons sequentially approach the display screen 22a in this manner, even though sizes of the icons are not changed according to the order of priority in the present embodiment, the icons approach a point of view in a sequence of the icon 12a, the icons 12b and 12c, and the icons 12d, 12e and 12f to be presented such that the sizes of the icons sequentially increase as illustrated in FIG. 19. Alternatively, an icon having a higher order of priority may be larger than an icon having a lower order of priority as illustrated in FIG. 13, and the configuration after rearrangement is not limited to a fan shape and may be arranged in a rectangular shape as illustrated in FIG. 12 or an annular shape as illustrated in FIG. 14.

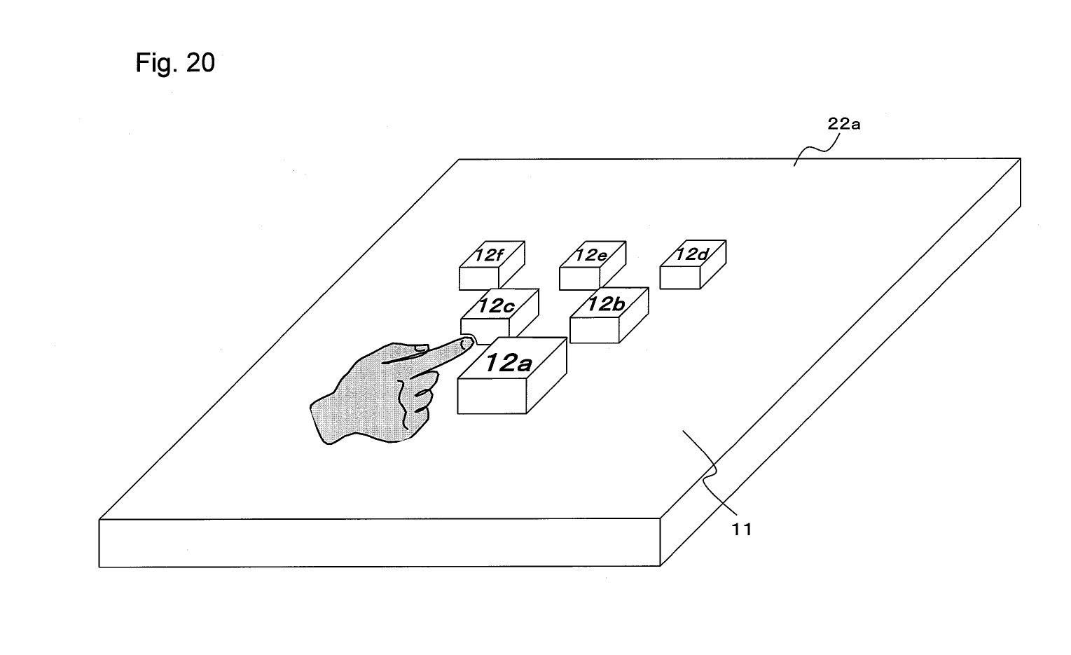

Subsequently, when a selection detecting unit 24 detects that any one of the icons 12a, 12b, 12c, 12d, 12e and 12f is selected, an application assigned to the selected icon is activated. The selection of an icon will now be described. A range in the XYZ coordinate system over which the icons 12a, 12b, 12c, 12d, 12e and 12f are to be three-dimensionally displayed is set in advance by the screen component creating unit 19. For example, the coordinates of the eight vertices of the respective parallelepiped-shaped icons 12 that the user confirm by sight are set in advance by the screen component creating unit 19 and, as illustrated in FIG. 20, when the finger 30 enters this range, the icon 12c is assumed so as to be selected. A position of the finger 30 is sampled at predetermined intervals and detected according to capacitance variation by the capacitance panel 14.

Moreover, a known method may be used as the three-dimensional display method, and while 3D glasses and the like may be used, it is more favorable to adopt a glasses-free three-dimensional display method by inserting a filter in the displaying unit 11 or the like. Glasses-free three-dimensional display methods include a parallax barrier method and a lenticular lens method.

In addition, when selecting any of the icons 12, the entry of the finger 30 into a range of an icon 12 may be notified to the user by, for example, changing the color of the icon 12 when the finger 30 enters a range defined by the coordinates of the eight vertices.

### Fourth Embodiment

Next, an input device according to a fourth embodiment of the present invention will now be described. While the input device according to the present fourth embodiment is basically configured the same as that according to the third embodiment, a display state of the present fourth embodiment differs from that of the third. Therefore, a description will be given focusing on this difference.

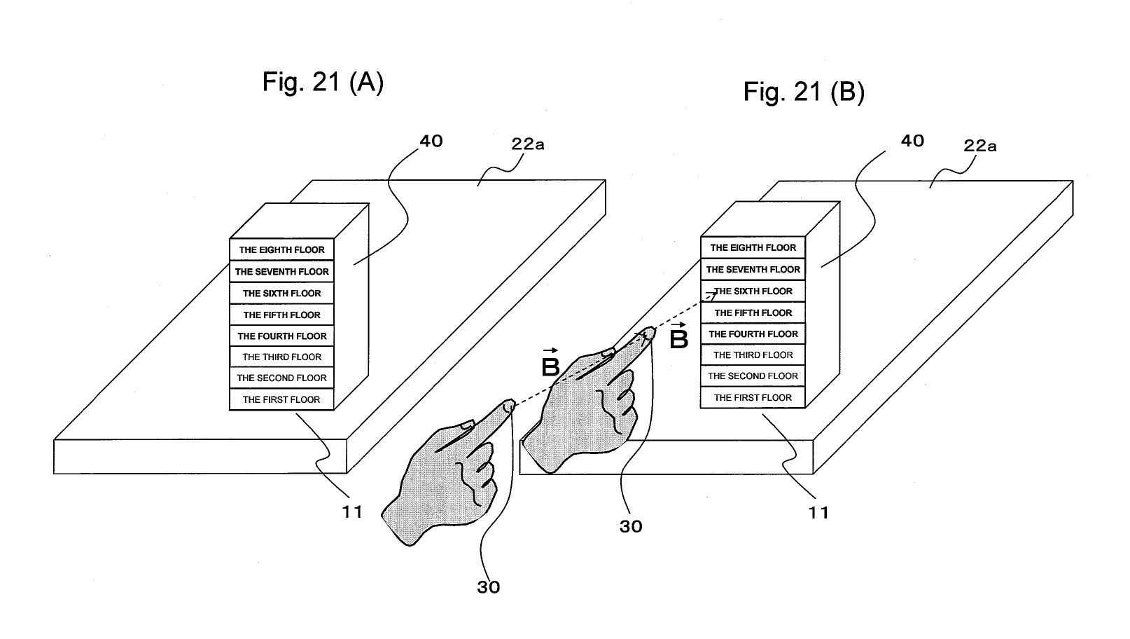

FIG. 21(A) is a perspective configuration diagram of the input device according to the present fourth embodiment. As illustrated in FIG. 21(A), with the input device according to the present fourth embodiment, an image of a building 40 is three-dimensionally displayed before a finger 30 approaches. The building 40 has, for example, eight floors from the first to the eighth, and tenants exist on each floor.

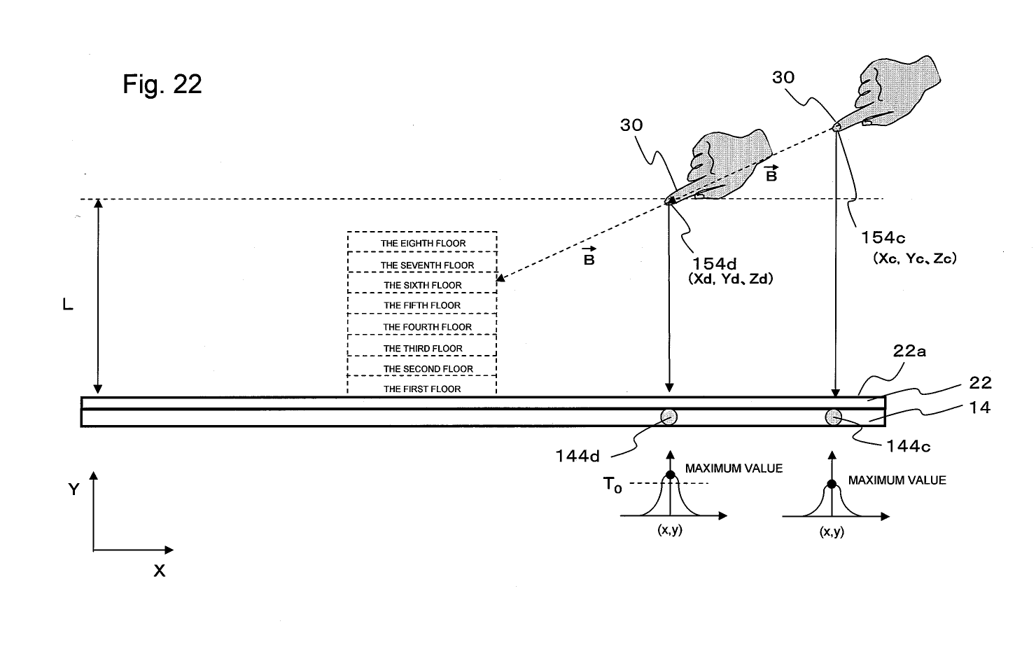

FIG. 21(B) is a perspective configuration diagram of the input device illustrating a state where the finger 30 is approaching the building 40. FIG. 22 is a side configuration diagram of the input device illustrating a state where the finger 30 is approaching the building 40.

When the finger 30 approaches a display screen 22a as illustrated in FIG. 21(B) and a detection is made that the finger 30 enters within a distance L of the display screen 22a in a z-axis direction as illustrated in FIG. 22, the detection point is assumed to be a final detection point 154d. Subsequently, a trajectory of the finger 30 is calculated by a trajectory calculating unit 17 from positions in an XYZ coordinate system of the final detection point 154d (coordinates (Xd, Yd, Zd)) and a detection point 154c (coordinates (Xc, Yc, Zc)) where variation is detected so as to be maximum during an immediately previous sampling.

Specifically, a vector is calculated from the coordinates of the two positions by the trajectory calculating unit 17. In other words, the trajectory calculating unit 17 calculates a vector B (Xd−Xc, Yd−Yc, Zd−Zc) from the position (Xc, Yc, Zc) to the position (Xd, Yd, Zd).

Using the calculated vector B, a direction estimating unit 23 estimates a direction in which the finger 30 is going to move. In other words, the direction estimating unit 23 estimates that the finger 30 is going to move in the direction of vector B from the position of the final detection point 154d (Xd, Yd, Zd). For example, in the present embodiment, it is estimated that the finger 30 is going to move to a sixth floor portion of the three-dimensionally displayed building 40.

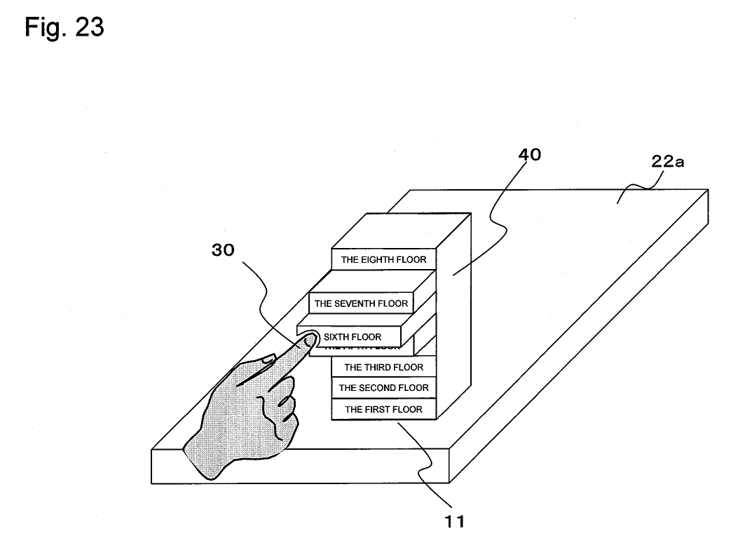

Subsequently, as illustrated in FIG. 23, a screen component creating unit 19 creates screen components forming the respective floors such that the sixth floor portion protrudes to the front like a drawer and the fifth and seventh floors around the sixth floor also protrude to the front. In this case, since an estimated direction of the finger 30 is the sixth floor portion and the priority of the sixth floor portion therefore becomes highest, screen components are created by an image display control unit 21 so that the sixth floor portion protrudes the most toward the front. The created screen components are then rearranged by an image processing unit 18 and displayed on a display panel 13 by the image display control unit 21. An example of screen components according to the present invention corresponds to the first to eighth floor portions according to the present embodiment. In addition, in the present embodiment, while the fifth floor portion and the seventh floor portion are displayed protruded toward the front together with the sixth floor portion at center, only the sixth floor portion may be protruded or other floors may be protruded together. Moreover an example of a display panel that three-dimensionally displays a plurality of screen components according to the present invention corresponds to the display panel 13 that screen components are three-dimensionally displayed before a finger 30 approaches according to the present fourth embodiment.

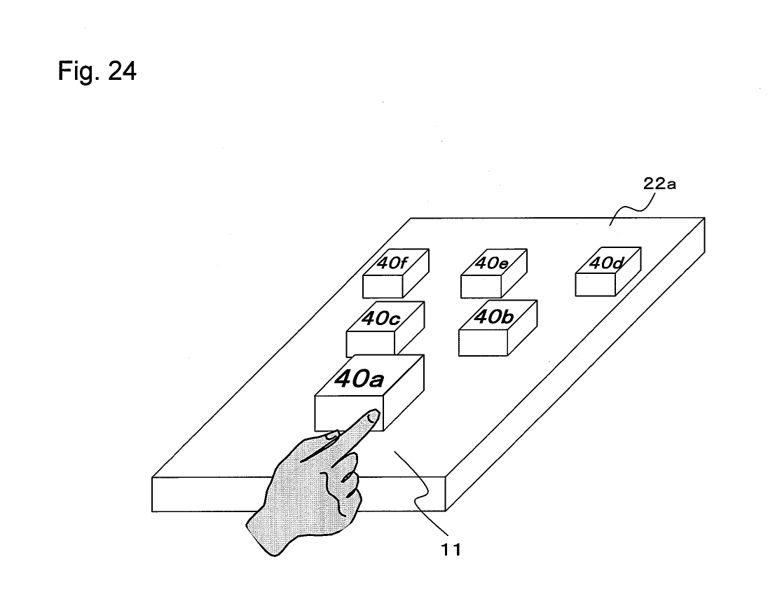

Subsequently, when a selection detecting unit 24 detects that the finger 30 penetrates into an area of the sixth floor portion, it is assumed that the sixth floor portion is selected and tenants in the sixth floor portion are displayed as illustrated in FIG. 24. FIG. 24 displays tenant icons 40a, 40b, 40c, 40d, 40e, and 40f. In this case, while the tenant icons 40a, 40b, 40c, 40d, 40e, and 40f are prioritized and three-dimensionally displayed in a fan shape such that the higher the priority of a tenant icon, the nearer the tenant icon is to the finger 30, the tenant icons may alternatively be arranged without prioritization or arranged according to an actual layout of the sixth floor portion. Furthermore, control may be performed such that by selecting any of the tenant icons 40a, 40b, 40c, 40d, 40e, and 40f, a web shop of the selected tenant is displayed on the screen.

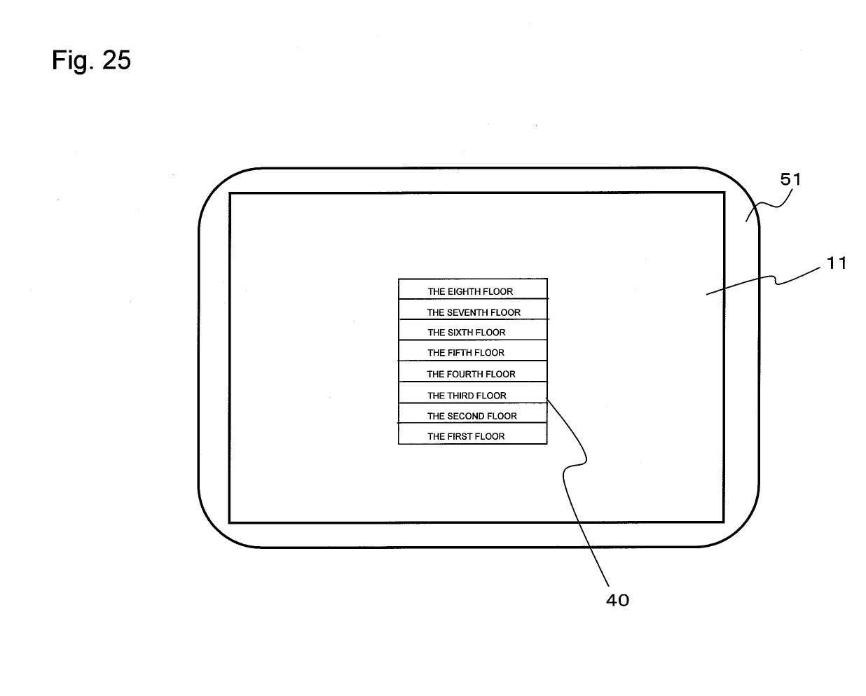

Moreover, in the present embodiment, while the building 40 is three-dimensionally displayed even before the approach of the finger 30, the building 40 may not be three-dimensionally displayed until the finger 30 enters within a distance L of the display screen 22a. For example, as illustrated in FIG. 25, when the building 40 is two-dimensionally displayed on the displaying unit 11, if an intersection P of a straight line extended from the final detection point in a direction of a vector K obtained from the final detection point and an immediately previous detection point and the display screen 22a indicates the sixth floor portion as described with reference to FIG. 16, then the building 40 is three-dimensionally displayed with the sixth floor portion protruding the most as illustrated in FIG. 20. In addition, when the intersection P indicates another floor, the building 40 is three-dimensionally displayed with the other floor protruding the most.

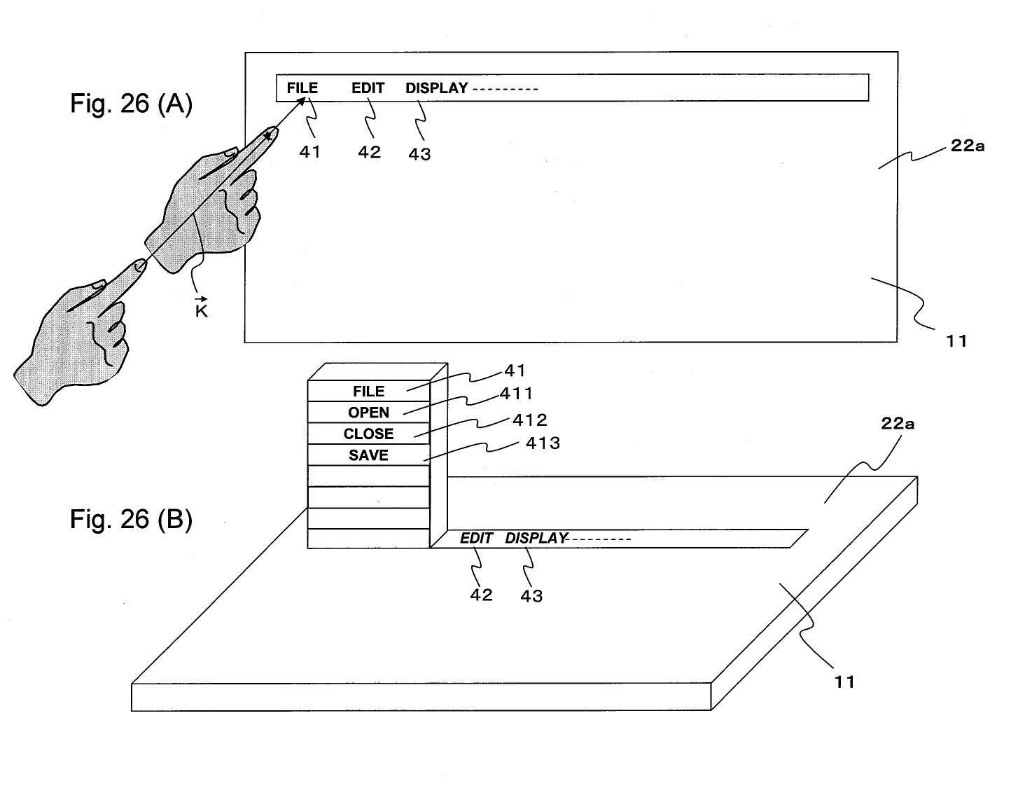

Furthermore, while an example of screen components according to the present invention corresponds to the first to eighth floor portions according to the present fourth embodiment, screen components are not limited to the first to eighth floor portions. Alternatively, for example, the screen components may be icons representing a “file” display portion 41, an “edit” display portion 42, a “display” display portion 43 and the like in a display of the “Excel (registered trademark)” program as illustrated in FIG. 26. Even in this case, the direction estimating unit 23 estimates which icon is indicated by the intersection P of a straight line extended from the final detection point in a direction of a vector K obtained from the final detection point and an immediately previous detection point and the display screen 22a. When the intersection P indicates the “file” display portion 41, as illustrated in FIG. 26, the “file” display portion 41 is three-dimensionally displayed, and an “open” display portion 411, a “close” display portion 412, a “save” display portion 413 and the like which are subordinate to the “file” display portion 41 are displayed under the “file” display portion 41. Subsequently, when any of the display portions is selected, processing corresponding to the display is executed. An example of screen components according to the present invention corresponds to the “file” display portion 41, the “edit” display portion 42, and the “display” display portion 43.

In the third and fourth embodiments described above, while a direction in which the finger 30 is going to move is estimated from the final detection point and the immediately previous detection point, a direction may be estimated by calculating an approximate straight line from detection points as is the case of the second embodiment.

Furthermore, in the case of the input device according to the present embodiment, since a user normally holds the display screen 22a by the hand to view the same, a distance between a point of view of the user and the display screen 22a is generally 20 to 30 cm. The distance by which three-dimensional displays are to be presented as though floating from the display screen 22a may be set based on this distance.

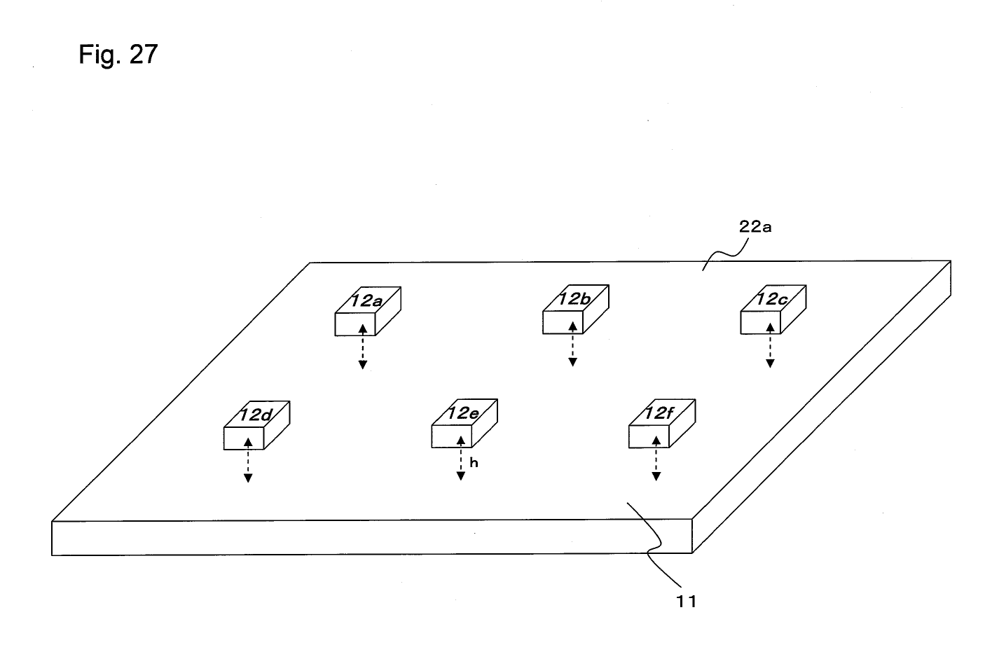

In addition, while three-dimensional display is not performed before the finger 30 approaches in the third embodiment, the icons 12a, 12b, 12c, 12d, 12e, and 12f may be three-dimensionally displayed even before the approach of the finger 30 as is the case of the building 40 according to the fourth embodiment. FIG. 27 illustrates a state where the icons 12a, 12b, 12c, 12d, 12e, and 12f are three-dimensionally displayed as described above. In FIG. 27, the respective icons 12a, 12b, 12c, 12d, 12e, and 12f are presented as though floating from the display screen 22a by a distance h.

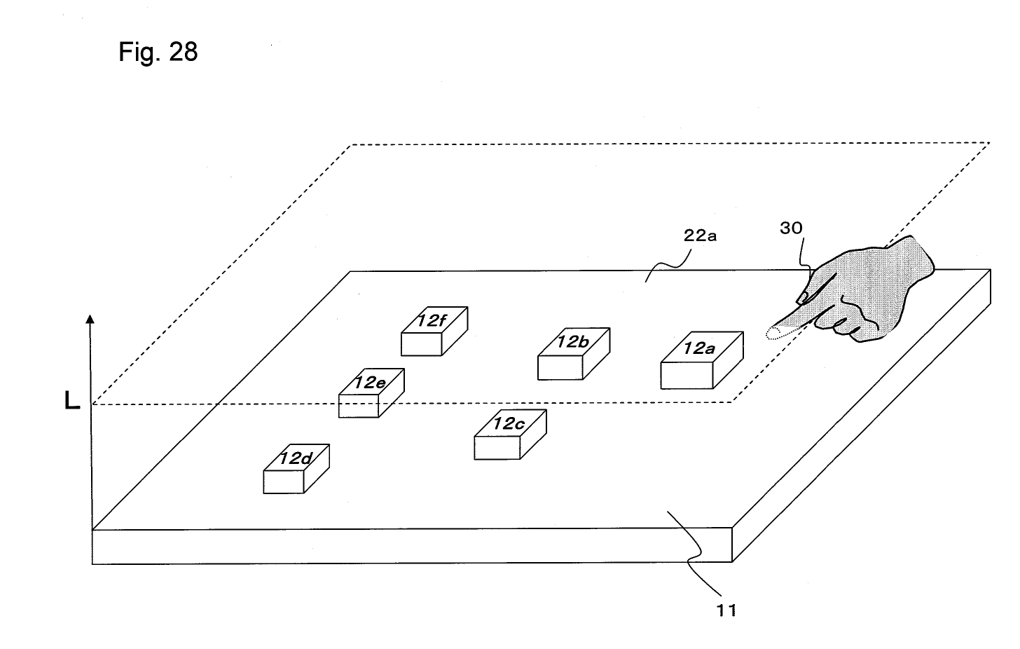

When the finger 30 approaches to within a distance L of the display screen 22a, the icons 12a, 12b, 12c, 12d, 12e, and 12f are rearranged according to their priorities as illustrated in FIG. 28 from the state illustrated in FIG. 27. In FIG. 28, a tip of the finger 30 entering within the distance L of the display screen 22a is indicated by a dotted line, and in the same manner as in FIG. 18 and FIG. 19, the icons 12a, 12b, 12c, 12d, 12e, and 12f are rearranged such that the higher the priority of an icon, the nearer the icon is arranged to the finger 30.

In addition, while an example of a designating object according to the present invention corresponds to the finger 30 in the embodiments described above, such a configuration is not restrictive and a pointing device such as a stylus may be used instead.

Moreover, a program according to the present invention is a program which causes operations of respective steps of the aforementioned input method according to the present invention to be executed by a computer and which operates in cooperation with the computer.

In addition, a recording medium according to the present invention is a recording medium on which is recorded a program that causes a computer to execute all of or a part of operations of the respective steps of the aforementioned input method according to the present invention, and which is a readable by the computer, whereby the read program performs the operations in collaboration with the computer.

Furthermore, the aforementioned “operations of the respective steps” of the present invention refer to all of or a part of the operations of the step described above.

Moreover, one utilizing form of the program of the present invention may be an aspect of being recorded on a recording medium, ROM and the like are included, which can be read by a computer, and operating with collaborating with the computer.

In addition, one utilizing form of the program of the present invention may be an aspect of being transmitted inside a transmission medium, transmission media such as the Internet, light, radio waves, and acoustic waves and the like are included, being read by a computer, and operating with collaborating with the computer.

Furthermore, a computer according to the present invention described above is not limited to pure hardware such as a CPU and may be arranged so as to include firmware, an OS and, furthermore, peripheral devices.

Moreover, as described above, configurations of the present invention may either be realized through software or through hardware.

The input device and the input method according to the present invention are capable of achieving the advantage of improved operability and are useful as an information terminal and the like.

What is claimed is:

1. An input device comprising:
a display panel that displays a plurality of screen components;
a trajectory detecting unit that detects a trajectory of movement of a designating object for selecting the screen components;
a direction estimating unit that estimates a direction in which the designating object is going to move, from the trajectory;
a display control unit that rearranges the plurality of screen components based on the estimated direction; and
a selection detecting unit that detects that one of the screen components is selected by the designating object.

2. The input device according to claim 1, further comprising
an approach detecting unit that detects that the designating object enters within a predetermined distance of the display panel, wherein
the display control unit rearranges the plurality of screen components when the designating object enters within the predetermined distance of the display panel.

3. The input device according to claim 2, wherein
the trajectory detecting unit includes a capacitance panel disposed on the display panel and a trajectory calculating unit that computes a trajectory based on output from the capacitance panel, and
the approach detecting unit detects the entering based on output from the capacitance panel.

4. The input device according to claim 2, wherein
the trajectory detecting unit detects the trajectory by performing sampling at a predetermined sampling interval, and
the direction estimating unit estimates the direction in which the designating object is going to move from a position where the entering of the designating object is detected by the approach detecting unit and a position where the designating object is detected by the trajectory detecting unit immediately prior to the detection of the entering.

5. The input device according to claim 2, wherein
the trajectory detecting unit detects the trajectory by performing sampling at a predetermined sampling interval, and
the direction estimating unit estimates the direction in which the designating object is going to move from a position where the entering of the designating object is detected by the approach detecting unit and a plurality of positions where the designating object is detected by the trajectory detecting unit before the detection of the entering.

6. The input device according to claim 1, wherein
the display control unit rearranges the plurality of screen components so as to form a fan shape that spreads wider in the estimated direction from the side of the designating object.

7. The input device according to claim 1, wherein
each of the plurality of screen components is assigned a priority beforehand, and
the display control unit rearranges the plurality of screen components such that the higher a priority of a screen component is, the nearer to the designating object the screen component is arranged.

8. The input device according to claim 1, wherein
the display control unit rearranges the plurality of screen components on the side of the estimated direction of the designating object.

9. The input device according to claim 1, wherein
the display control unit rearranges the plurality of screen components so as to be three-dimensionally displayed.

10. The input device according to claim 9, wherein
the display panel three-dimensionally displays the plurality of screen components.

11. The input device according to claim 8, wherein
the trajectory detecting unit three-dimensionally detects a trajectory of the designating object, and
the display control unit rearranges the plurality of screen components in a vicinity of an intersection of the estimated direction and the display panel.

12. An input method comprising:
a display step of displaying a plurality of screen components on a display panel;
a trajectory detecting step of detecting a trajectory of movement of a designating object for selecting the screen components;
a direction estimating step of estimating a direction in which the designating object is going to move, from the trajectory;
a rearrangement step of rearranging the plurality of screen components based on the estimated direction; and
a selection detecting step of detecting that one of the screen components is selected by the designating object.

13. A program embodied on a non-transitory computer-readable medium, the program causing a computer to execute the input method according to claim 12.
